(19) United States
(12) Patent Application Publication
(10) Pub. No.: US 2022/0414699 A1
(43) Pub. Date: Dec. 29, 2022

(54) VARIABLE LEVEL COMPENSATION SYSTEM AND METHODS FOR GOODSAND SERVICES

(71) Applicant: Brett A. Kelly, Hobe Sound, FL (US)

(72) Inventor: Brett A. Kelly, Hobe Sound, FL (US)

(21) Appl. No.: 17/836,858

(22) Filed: Jun. 9, 2022

Related U.S. Application Data
(60) Provisional application No. 63/209,202, filed on Jun. 10, 2021.

(51) Int. Cl. G06Q 30/02

(52) U.S. Cl. CPC G06Q 30/0209; G06Q 30/0214

(57) ABSTRACT

A method including communicating a game establishment message to an online gaming system application server computing device identifying that an enhanced member would like to establish a tournament; communicating a message to the online skilling gaming application server computing device identifying a type of online skill game to be conducted and communicating a message to the online skilling gaming application server identifying a number of players allowed in the online skill gaming tournament; an entry fee for the online skill gaming tournament; a prize money distribution schedule for the online skill gaming tournament; communicating a report of the enhanced member's network level list to allow an enhanced member to identify levels of members who may be targeted to participate in the online skill gaming tournament; generating a commission distribution schedule for the online skill gaming tournament; and communicating the commission distribution schedule to the online skill gaming system application server.

### RELATED APPLICATIONS

This application is related to and claims priority to the U.S. provisional patent application Ser. No. 63/209,202, filed Jun. 10, 2021, entitled “VARIABLE LEVEL COMPENSATION SYSTEM AND METHODS FOR GOODS AND SERVICES, the disclosure of which is hereby incorporated by reference.

### BACKGROUND OF INVENTION

Many individuals engage in online skill gaming due to lack of proximity of casinos and/or card games in areas where the individuals live. In embodiments, online skill gaming providers and/or companies look to attract members to play because an online skill gaming providers margins may be low and these companies need to attract as many members as possible. Accordingly, a need exists to attract individuals who not only play online skill games, but also to attract individuals who can also recruit, attract or influence additional new members.

### BRIEF DESCRIPTION OF DRAWINGS

FIG. 1 is a functional block diagram illustrating a distributed data processing environment in an online skill gaming system according to embodiments;

FIG. 2 illustrates a functional block diagram of a mobile computing and/or communications device utilize in an online skill gaming system according to embodiments;

FIG. 3 illustrates a flowchart of a process or method for joining an online skill gaming platform according to embodiments;

FIG. 4A illustrates a method and/or process for an enhanced member establishing an online gaming tournament according to embodiments;

FIG. 4B illustrates a method and/or process for an enhanced member establishing an online gaming tournament according to embodiments;

FIG. 5A illustrates a method and/or process for a charitable organization and/or celebrity member establishing an online gaming tournament according to embodiments;

FIG. 5B illustrates a method and/or process for a charitable organization and/or celebrity member establishing an online gaming tournament according to embodiments;

FIG. 6A illustrates a computer-implement method and/or process for establishment and execution on an online skill gaming tournament by an online skill gaming entity according to embodiments;

FIG. 6B illustrates a computer-implement method and/or process for establishment and execution on an online skill gaming tournament by an online skill gaming entity according to embodiments;

FIG. 7A illustrates an enhanced member setting up and establishing an online skill game where a prize may be a life experience according to embodiments;

FIG. 7B illustrates an enhanced member setting up and establishing an online skill game where a prize may be a life experience according to embodiments; and

FIG. 8 illustrates selling of goods and services and distribution of commissions on an online skill gaming application server according to embodiments.

FIG. 9 is a functional block diagram illustrating a distributed data processing environment 100 for use by entities operating in an online environment.

FIG. 10 is a description of compensation systems and methods applied to insurance or annuities market according to some implementations;

FIG. 11 is a description of compensation systems and methods applied to selling or distributing software according to some implementations;

FIG. 12 is a description of compensation systems and methods applied to distributing content or paid content according to some implementations; and

FIG. 13 is a description of compensation systems and method applied to selling sports-related products according to some implementations.

### DETAILED DESCRIPTION OF INVENTION

Although an example online gaming system network architecture and/or structure is disclosed, this description is illustrative and may be implemented by any number of online network structures. In embodiments, web or online applications, operating on web and/or application servers, include JavaServer Page (JSP) technology, which generates web pages based on HTML, XML, and/or other document types. In other embodiments, Hypertext PreProcessor (PHP) is an open-source page scripting/templating system similar to JSP and descriptions herein also apply to PHP. JSPs often include dynamic content, which may be content retrieved from a file or database, and static content, which may be stored on a web server and/or application server. In embodiments, a computing device may access a website on a web server (and/or application server), and a web application may generate a web page dynamically, building a web page from dynamic elements accessed from files or databases, for example, and static content stored on the web server. Dynamically generating the web page by the web server creates a challenge when applications of this type are considered for use by mobile devices. In embodiments, when application servers are performing these actions, mobile communication and/or computing devices may experience a performance issue for most mobile devices. In such embodiments, static content (which does not require access of a database or other external storage device) may be transferred to a mobile communications device and/or mobile computing device and stored in a file and/or a container in the mobile device. In embodiments, downloaded static content may be associated with a website of the web server. Thus, during subsequent accesses of the web site, embodiments may complete a build of the web page by use of the dynamic content downloaded at the time of access and static content stored locally within the container or file on the mobile computing or communications device that had been downloaded previously.

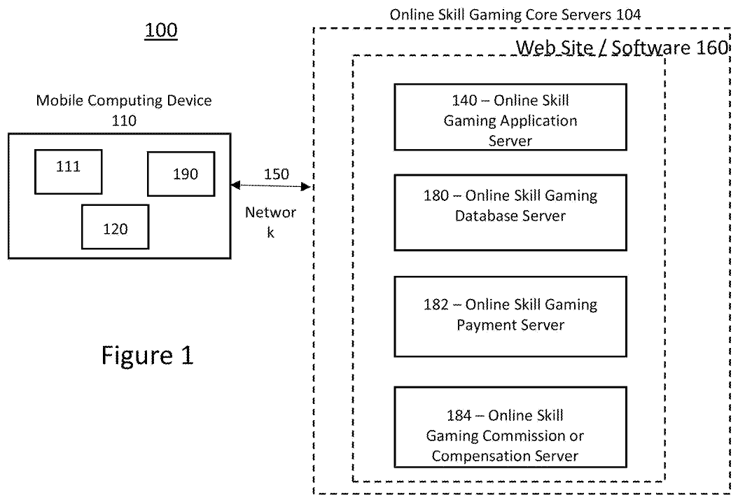

FIG. 1 is a functional block diagram illustrating a distributed data processing environment in an online skill gaming system, generally designated 100. In embodiments, an online skill gaming system 100 (e.g., in a distributed data processing environment) may comprise a mobile communications and/or computing device 110, which may comprise a web content program 111, a container or memory storage for static data 120, and/or a browser 190 for interacting with servers. In embodiments, an online skill gaming system 100 (e.g., in a distributed data processing environment) may also comprise online skill gaming core servers 105 which operate a web site of an online skill gaming company. In embodiments, one or more online skill gaming core servers 105 may comprise a database (or database server) 180, and an application server (e.g., or web server 140), shown hosting computer-readable instructions that may be executed by one or processors on an application server. In embodiments, an online skill gaming system 100 may further comprise a payment serer 182 (or payment processing server) and/or a commission or compensation or commission server 184. In embodiments, a database server 180, an application server 140, a payment server 182 and/or a compensation server 184 may form a core network of servers. In embodiments, such a core network of servers may be resident and/or installed on one physical computing devices (or servers) or more than one physical computing device and/or servers. In embodiments, such a core network of servers may be resident on cloud-based servers. In embodiments, computer-readable instructions may be executable by one or more processors on one or more of the core servers to implement the online skill gaming system 100. In embodiments, computer-readable instructions executable by one or more processors may be referred to as an online skill gaming website 160 (e.g., web application 160) along with static content. In embodiments, an application and/or web server 140, a database and/or database server 180, a payment server 182 and/or a compensation server 184, and/or a mobile computing or communication device 110 may be connected via a communications network 150. In embodiments, online skill gaming core servers may be utilized along with or in place of application server 140, payment server 182, database server 180 and/or commission or compensation server 184.

In embodiments, network 150 may be, for example, a local area network (LAN), a telecommunications network, a wide area network (WAN), such as the Internet, a virtual local area network (VLAN), or any combination that can include wired, wireless, or optical connections. In general, network 150 may be any combination of connections and protocols that may support communications between the applications and components of web and/or application server 140, a database or database application server 180, and the applications and components of mobile computing and/or communications device 110.

In embodiments, an online skill gaming web or application server 140 may be a computing device, a server, a network device, that is not local and/or may be remote to a mobile computing and/or communications device 110. In embodiments, an online skill gaming application server or web server 140 may comprise an online skill gaming web or software application 160, and online skill gaming static content 170 which may be retrieved utilizing a software application. In embodiments, an online skill gaming application server or web server 140 may generate web pages in response to requests to access an online skill gaming website operated by an online skill gaming web or software application 160.

In embodiments, an online skill gaming application server or web server 140, a database server 180, a payment processing server 182 and/or a compensation server 184 (e.g., a core network of servers) may be a management server, a web application server may be resident and/or installed in a blade server, a mobile computing or communications device, a computing device, or other electronic device or computing system capable of receiving and sending data. In embodiments, an online skill gaming application or web server 140, a database server 180, a payment processing server 182 and/or a compensation server 184 (e.g., a core network of servers) may represent a virtual computing device of a computing system utilizing multiple computers as a server system, such as in a cloud computing environment (e.g., or cloud computing servers). In embodiments, an online skill gaming application or web server 140, a database server 180, a payment processing server 182 and/or a compensation server 184 (e.g., a core network of servers) may be installed and/or resident on a laptop computer, a tablet computer, a netbook computer, a personal computer (PC), a desktop computer, a personal digital assistant (PDA), or any programmable electronic device capable of access to a network 150, and performing the operational steps of an online skill gaming software or web application 160. In embodiments, an online skill gaming application or web server 140, a database server 180, a payment processing server 182 and/or a compensation server 184 (e.g., a core network of servers) may represent a computing system utilizing clustered computers and/or components (e.g., database server computers, application server computers, etc.) that act as a single pool of seamless resources when accessed within distributed data processing environment 100. In embodiments, an online skill gaming application or web server 140, a database server 180, a payment processing server 182 and/or a compensation server 184 (e.g., a core network of servers) may include internal and external hardware components (e.g., one or more memory modules, one or more processors, one or more network adapters and/or transceivers, one or more monitors or displays).

In embodiments, an online skill gaming software or web application 160 may include JSPs and/or PHPs, which support a website on an online skill gaming application or web server 140, which may be referred to as an online skill gaming web application server. In embodiments, an online skill gaming software or web application 160 may be accessed by setting up, establishing and/or providing a uniform resource identifier (URI) that corresponds to a website supported by and/or executing an online skill gaming software or web application 160, to an online skill gaming web content program or software application 210 that may be stored and/or resident on a mobile computing and/or communication device 110. A URI may also be classified as a locator, a name, or both, e.g., a term Uniform Resource Locator (URL) may be a type of URI, and refers to the subset of URIs that, in addition to identifying a resource, provide a way or method of locating a resource (e.g., a website) by its network location. For simplicity and consistency, references to accessing or receiving content from a website may refer to a URL, with the understanding that a URL may both identify and locate a website, and thus a URL may correspond to a website. In an online skill gaming system, a URL may be utilized to specifically identify members of the online gaming system. In embodiments, a URL may identify a host address of a member in an online skill gaming system

In embodiments, when accessed by a URL link, an online skill gaming software or web application 160 may generate a web page associated with the particular URL that corresponds to the website. In embodiments, generation of a web page may include references to static content stored on an online skill gaming application or web server 140, and/or dynamic content of an online skill gaming application or web server. In embodiments of the present invention, dynamic content used by an online skill gaming software and/or web application 160 may generate a web page may reside in files stored on an online skill gaming application and/or web server 140, may be accessed from a database or database server 180, a payment processing server 182, and/or a compensation server or may be accessed from other sources and/or databases which may be connected to connected to communications network 150 (not shown). In embodiments, online skill gaming software or web application 160 may dynamically generate a web page associated with a particular URL link when the URL is accessed by another computing device, such as mobile computing and/or communications device 110, and builds the web page each time the URL is accessed, by retrieving and combining dynamic and static content.

In embodiments, static content 170 may include a web page “static resources” that remain constant through multiple builds and displays for multiple users of a web page associated with a particular website. In embodiments, online skill gaming static content 170 may include for example, but are not limited to, cascading style sheets (CSS), formatting content, hypertext markup language (HTML) files, JavaScript, and images associated with a website owned and/or operated by an online skill gaming owner and/or operator. Although online skill gaming static content 170 may be updated, it is characterized by not varying based on the user or entity accessing the web page, or the frequency of accessing the web page, of the website.

In embodiments, an online skill gaming database server or database 180, a payment processing server 182 and/or a compensation server 184 may be a source of data that is used by online skill gaming software or web application 160 to provide dynamic content to a web page generated by an online skill gaming software and/or web application or web site 160 on an online skill gaming web server and/or application server 140, a database server 180, a payment processing server 182 and/or a compensation server 184 (e.g., a core network of servers). In embodiments, an online skill gaming database server and/or database 180 may include, for example, profile or settings data for individual users that access an online skill gaming website that is supported by an online skill gaming software and/or web application 160. The profile or settings data may provide user-specific information, such as name, account number, and status, or may display user preferences, such as language and may include values associated with monetary and/or point values. In some embodiments of the present invention, dynamic content may be accessed from files, tables, or other storage structures, accessible to an online skill gaming software or web application, such as online skill gaming web application 160. In embodiments, a payment processing server 182 may comprise computer-readable instructions executable by one or more processors that handle communications with external payment processing servers, financial institutions, credit or debit card institutions; handle virtual money (e.g., FantaZ wallet transmission; and/or handle communications with other core network servers in an online skill gaming system 100 (e.g., a database server 180, a compensation server 184 and/or an online skill gaming application server 140. In embodiments, a compensation server 184 may comprise computer-readable instructions executable by one or more processors that handle member network compensation accounts, member network affiliate level identification, commission distributions to members, bonus pool distributions to members, and monetary distributions to an online skill gaming company (e.g., FantaZ) normally a bank account.

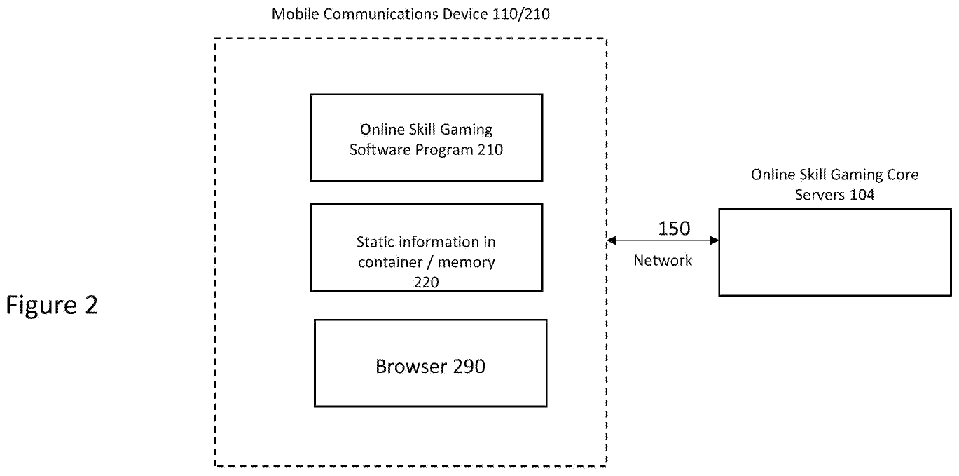

FIG. 2 illustrates a functional block diagram of a mobile computing and/or communications device utilize in an online skill gaming system according to embodiments. In embodiments, a mobile computing and/or communications device 110 may be a computing device that comprises an online skill gaming software or web content program 210, a container that may store online skill gaming static information 220 and a browser 290. In embodiments, mobile computing and/or communications device 110 may be any mobile electronic device or mobile computing system capable of receiving and sending data. In embodiments, mobile computing device 110 may represent a virtual instance of a computing device generated from a computing system utilizing multiple computers as a server system, such as in a mobile device connected to a cloud computing environment. In another embodiment, mobile computing device 110 may be a laptop computer, a tablet computer, a netbook computer, a personal computer (PC), a personal digital assistant (PDA), a smart phone, or any mobile programmable electronic device capable of performing the operational steps of an online skill gaming software and/or web content program 210, via network 150. Mobile computing device 110 may include internal and external hardware components, as depicted in FIG. 2 and further including computer-readable instructions stored in one or more memory modules and executed by one or more processors. In embodiments, mobile computing and/or communications device 110 may comprise one or more transceivers.

In embodiments, a browser 290 may be a software application (e.g., computer-readable instructions executed by one or more processors of a mobile computing and/or communications device 110 that may enable access to and viewing of content from websites on the World Wide Web (or global communications network0, using access to the Internet via communications network 150. In embodiments, browser 290 may typically receive a URL from input or selection of a link and accesses and displays web site content associated the URL.

In embodiments, an online skill game may be an online game which requires player skill in order to play. In embodiments, an online skill game may be online games that require skill to engage in and compete and/or that have been determined by legal professionals, gaming organizations and/or gaming commissions to require skill to play. In embodiments, online skill games require that a participant's skill defines an outcome of an online skill gaming tournament. In embodiments, an online skill game has randomness of outcome's removed between different players and skill is required in order to win and/or play a game successfully. In embodiments, as an example of an online skill game, an online skillified poker and/or blackjack game may meet both state and/or federal regulations for skill games because randomness has been removed. In embodiments, randomness may be removed in an online skillified poker and/or blackjack game by removing a randomness with which the cards are dealt and/or distributed to each player in each hand of an online skill gaming tournament. In embodiments, randomness may be removed by removing variables of card shuffle which results in players having to make decisions in an online skill game (e.g., or tournament) based on the exact same variables (cards). In embodiments, randomness may be removed by making all of the players start an online skill game tournament with a same amount of (virtual) money, which results in no player having an unfair advantage. In embodiments, such game play may require a player therefore to use skill to manage a player's bank roll. In embodiments, Bricks Breaker, Pool, Chess, Solitaire, Challenge Pool may also be examples of online skill games.

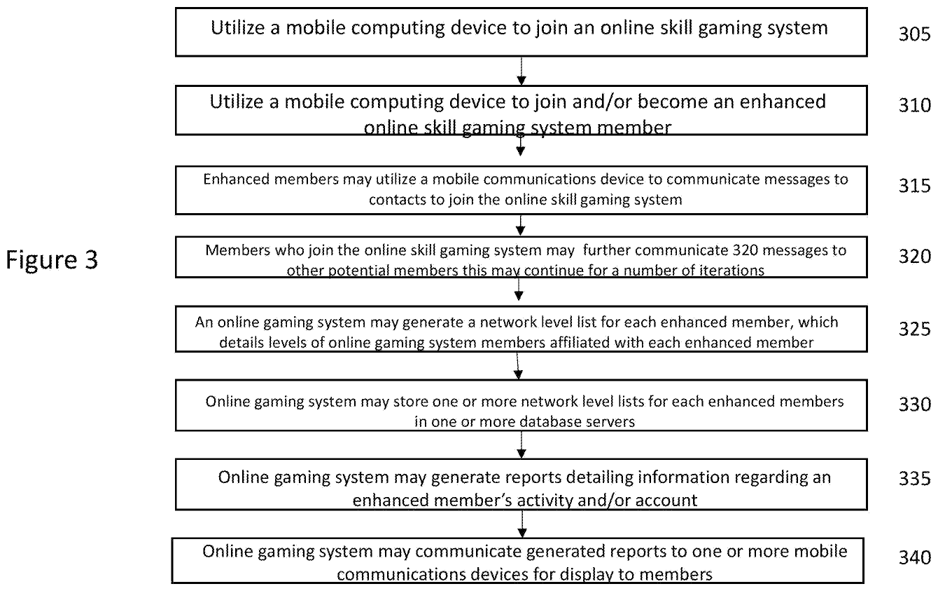

FIG. 3 illustrates a flowchart of a process or method for joining an online skill gaming platform according to embodiments. In embodiments, an online skill gaming system may be established utilizing one or more web application servers, one or more web database servers, one or more payment processing servers and/or one or more compensation servers and/or as illustrated in FIGS. 1 and 2. In embodiments, members may utilize a mobile computing device to join 305 an online skill gaming system. In embodiments, an online skill gaming system may be FantaZ gaming system. In embodiments, a member may enter personal information including name, age, bank account information (e.g., if playing for prize money), email contact, phone contact and other potential pertinent information. In embodiments, members may utilize a mobile computing device to join and/or become 310 an enhanced online skill gaming system member. In embodiments, this may require payment of an additional fee (e.g., transferring money to an online skill gaming system owner). In embodiments, this may require an online skill gaming system member signing up a predetermined number of additional skill gaming system members. In embodiments, in FantaZ online skill gaming system, enhanced members may be referred to as Z Business Owners (ZBOs), FantaZ Pros, and FantaZ Experts.

In embodiments, enhanced online skill gaming system members may utilize a mobile communications device to communicate messages 315 to other contacts to join the online skill gaming system. In embodiments, the messages may be communicated through a global communications network (e.g., an Internet and/or a world wide web) and/or online skill gaming system core servers (e.g., an online gaming web application server, a database server, and/or a compensation server) to potential members (and associated computing devices (e.g., mobile communication devices, personal computing devices and/or desktop and/or network computing devices). In embodiments, invited members who join the online skill gaming system may further communicate 320 messages to other potential members through a global communications network and/or an online gaming core servers (e.g., web application servers, etc.) and this may continue for a number of iterations. In embodiments, this may be referred to as establishing a downline of affiliated members. In embodiments, this may also be referred to as establishing a network of affiliates. For example, members who join an online skill gaming system may invite friends or contacts to join the online skill gaming system and those friends and/or contacts may invite their friends and/or contacts to join the online skill gaming system. In embodiments, messages may automatically be sent out via social media platforms, e.g., Instagram, Twitter, Facebook, to request potential members to join an online skill gaming system. In embodiments, for example, an enhanced member may include in an invitation message an enhanced member's URL to assist an invitee or member to join an online skill gaming system.

In embodiments, an online gaming system may generate 325 a network level list for each enhanced member, which details levels of online gaming system members affiliated with each enhanced member. In embodiments, an online gaming system enhanced member may have network levels up to a specified number of levels (e.g., 8, 50, 200, 500 and/or 500 levels of followers). In embodiments, an online gaming system may store 330 one or more network level lists for each enhanced members in one or more database servers. In embodiments, for example, in the FantaZ online gaming system, an enhanced member (e.g., ZBO/Pro/Expert) may have 8 levels of followers that they influence that form the enhanced FantaZ member's downline (e.g., downline affiliate hierarchy).

In embodiments, an online gaming system may generate 335 reports detailing information regarding an enhanced member's activity and/or account. In embodiments, generated reports may identify prize money earned, commission money earned, bonus money earned and/or prizes earned. In embodiments, generated reports may identify downline hierarchy structure and/or levels and performance of affiliated members. In embodiments, an online gaming system may communicate 340 generated reports to one or more mobile communications devices or computing devices for display to members.

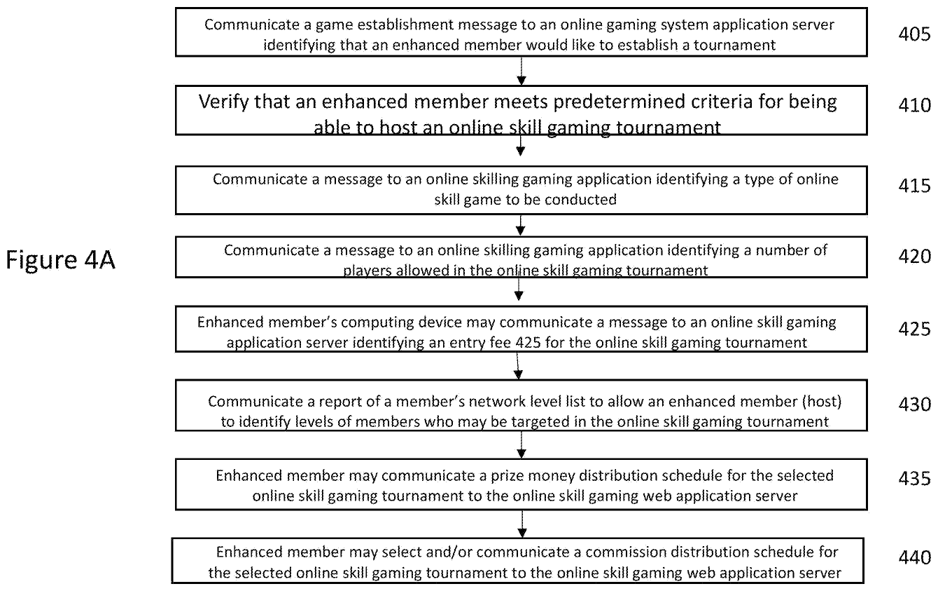

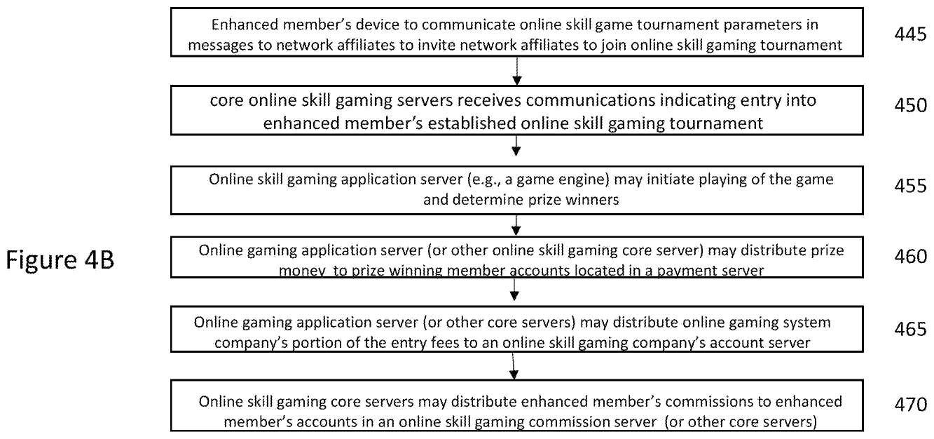

FIG. 4A illustrates a method and/or process for an enhanced member establishing an online gaming tournament according to embodiments. FIG. 4B illustrates a method and/or process for an enhanced member establishing an online gaming tournament according to embodiments. In embodiments, computer-readable software on a mobile communication device and/or computing device may communicate 405 a game setup/establishment message to an online gaming system application server identifying that an enhanced member would like to establish a tournament (e.g., may be a private tournament). In embodiments, an enhanced member may need to be commissioned qualified to initiate or establish a skill gaming tournament. In embodiments, computer-readable instructions executable by a processor of an online gaming system application server may verify 410 that an enhanced member meets predetermined criteria for being able to define and/or host a skill gaming tournament. In embodiments, if an enhanced member is verified, an enhanced member's computing device and/or mobile communications device may initiate communicating messages to an online skill gaming application server to set game rules and/or game distributions for the skill gaming tournament.

In embodiments, for example, an enhanced member's computing device (or mobile communications device) may communicate a message to an online skilling gaming application identifying a type 415 of skill game to be conducted and/or also whether the skill gaming tournament may be public and/or private. In embodiments, for example, an enhanced member's computing device (or mobile communications device) may communicate a message to an online skilling gaming application identifying a number of players 420 allowed in the skill gaming tournament. In embodiments, for example, an enhanced member's computing device (or mobile communications device) may communicate a message to an online skill gaming application server identifying an entry fee 425 for the online skill gaming tournament. In embodiments, these messages (415, 420, or 425 may be communicated to one or more of a core group of servers (e.g., an application server 140, a database server 180, a payment processing server 182 and/or a compensation server 184). In embodiments, optionally, an online skill gaming application may communicate a report and/or measurements of a member's network level list to allow an enhanced member (who established the tournament) to identify levels of members who may be targeted 430 in the skill gaming tournament. In embodiments, computer-readable instructions executable by a processor may perform analysis on the member network level list to identify targeted levels of members. For example, a member's network level list may identify that the member has 8 affiliates at level 1, 20 affiliates at level 2, 350 affiliates at level 3, and 10 affiliates each at levels 4-8. In embodiments, computer-readable instructions executable by a processor may identify that levels 1-3 should be targeted and that levels 4-8 may not be as important to an enhanced member.

In embodiments, an online skill gaming system may allow enhanced members to determine prize money distribution for an online skill gaming tournament. In embodiments, unlike prior compensation systems, an online skill gaming system may allow enhanced members to establish network level commission distributions as well as distributions within network levels for an online skill gaming tournament. In addition, an online skill gaming system may allow enhanced members to establish commission distributions within levels. In addition, an online skill gaming system may allow enhanced members to participate in and/or select distribution of bonus pools available for enhanced members.

In embodiments, an enhanced member may select and communicate a prize money distribution schedule 435 for the select online skill gaming tournament to the online skill gaming web application server. In embodiments, an enhanced member may select and communicate a prize money distribution schedule to one or more core servers (e.g., an online skill gaming application server 140, a database server 180, a payment processing server 182 and/or a compensation server 184. In embodiments, for example, an enhanced member may select that 1^{st}, 2^{nd} and 3^{rd} place may be awarded with 40% going to first place, 20% going to second place and 10% going to third place. In embodiments, 5% of a remaining portion of game entry fees may go to an online skill gaming company (game provider) (e.g., FantaZ-Holdings). In embodiments, 25% of a remaining portion of game entry fees may be selected for commission distributions. In embodiments, an online skill gaming company may have preset prize money distributions that are available for online skill gaming tournaments. In other words, an online skill gaming company (e.g., FantaZ Holdings) may establish that set guidelines for how prize money should be distributed.

In embodiments, an enhanced member may select and/or communicate a commission distribution schedule 440 for the selected online skill gaming tournament to the online skill gaming web application server and/or one or more core online skill gaming servers. In embodiments, for example, an enhanced member (who is hosting the online skill gaming tournament) may determine a number of network levels to which commissions are to be distributed. In embodiments, for example, an enhanced member may select that four network levels of affiliates may receive distributed commissions for the selected online skill gaming tournament. In embodiments, may also determine which levels (e.g., network levels) receive which percentage of the commission distributions. In embodiments, for example, if four network levels of affiliates are paid commissions, an enhanced member may select that network level 1 members may receive 15% of available commission distributions for the online skill gaming tournament, network level 2 members may receive 15% of available commission distributions, network level 3 members may receive 60% of available commission distributions and network level 4 members may receive 10% of available commission distributions.

This is a significant improvement on past commission structures. In past commission structures, a set number of 8 network levels received commission distributions and this number was not selected. Further, in embodiments, each network level received the same percentage of commission distributions (e.g., 12.5 percent per network level for 8 levels). In embodiments, an online skill gaming company may have previously had an established value that may be different at each level, but fixed by an online skill gaming company compensation plan. This provided a rigid commission structure and online game enhanced members would not be incentivized to participate in and/or promote games. Utilizing the present embodiment, an enhanced member may establish and/or setup a commission structure that incentivizes different network levels to promote the online skill gaming tournament. In embodiments, for example, utilizing the example provided above (e.g., 15% commission distribution to level 1; 15 commission distribution to level 2 and 60% commission distribution to level 3, etc.) provides an incentive to level 3 network partners to join in and/or promote the selected online skill gaming tournament.

In embodiments, an online skill gaming system may establish minimum and/or standard commission distribution schedules (e.g., identify how many network levels may receive commission distributions and what percentage of commission distributions may be assigned to each network level. In other words, in FantaZ online skill gaming, a FantaZ enhanced member Selects Levels of Affiliates for Payout (How many levels of downline will receive commissions). Further, in embodiments, a FantaZ Enhanced Member Selects Division of Proceeds Between Levels of Affiliates (what percentage does each level in downline receive).

In other words, an enhanced member who is able to define a number of levels to which the uni-level commission is paid out along with a payout percentage for each level. In embodiments, a total amount of uni-level commission may be established and/or predefined by an online skill gaming company and/or provider (e.g., FantaZ Holdings) of an online skill gaming tournament based on the entry fee and a total number of players. In embodiments, an online skill gaming company and/or provider may also define a minimum number of players that need to pay an entry fee and join a game before an online skill gaming tournament may pay commissions out. In embodiments, revenue from an online skill game tournament entry fees may be distributed to an enhanced member as a hosting fee. In embodiments, an enhanced member may select and/or communicate a hosting fee for the selected online skill gaming tournament to the online skill gaming web application server. In embodiments, for example, a hosting fee may be paid to an enhanced member (e.g., a 1% or 2% hosting fee). In embodiments, an online skill gaming tournament may pay a hosting fee to an enhanced member if an enhanced member has met certain milestones and/or targets established by an online skill gaming tournament (in FantaZ online skill gaming this enhanced member may be referred to as a Pro and/or Expert member).

In embodiments, an online skill gaming system application server may communicate selected online skill game tournament parameters to an enhanced member for verification. In embodiments, an enhanced member may utilize computer-readable instructions executed by a mobile communications device and/or computing device to communicate online skill game tournament parameters in messages to network affiliates to invite 445 network affiliate members to join the established online skill gaming tournament (which may also be referred to as a private online skill gaming tournament). In embodiments, invitations may be communicated via online social media platforms (e.g., Instagram, Facebook, Twitter) alone and/or in conjunction with the online skill gaming application server and/or other online skill gaming core servers. In embodiments, an invitation message may include an enhanced member's URL as an identifier and/or a link for which to join the selected or host online skill game. In embodiments, invitation messages and/or communications may include private online skill gaming tournament parameters such as Entry Fee, Prize Money Potential (or Life Experience potential), Commission Distribution to Enhanced Members. In embodiments, an enhanced members may only communicate messages to their direct network affiliates (e.g., Level 1) and/or targeted new FantaZ members who are not affiliated with any enhanced members. In embodiments, additional members may be targeted because an enhanced member's affiliate may invite their network affiliates who may then invite their network affiliates.

In embodiments, an online skill gaming system application server (or other core online skill gaming servers such as commissions server 184, payment server 182 and/or database server 180) receives 450 communications indicating entry into enhanced member's established online skill gaming tournament. In embodiments, an online skill gaming system application server may also receive payment information which may be communicated and/or transferred to a third party payment processing system for authentication that the potential skill gaming player has made an acceptable payment. In embodiments, an online skill gaming system may further comprise a payment server (e.g., or virtual payment server). In embodiments, online skill gaming system members and/or enhanced members may have payment accounts established (e.g., on a payment server 184) and thus may have virtual currency. In embodiments, the virtual currency may be utilized for entry fees in joining an online skill gaming tournament. In FantaZ online gaming system, this may be referred to as a virtual wallet. In embodiments, network affiliates, affiliates of network affiliates and affiliates of affiliates of network affiliates (and so on) may join the established online skill gaming tournament. In embodiments, invited players who are not members on an online skill gaming platform may be invited to join the platform in order to enter the online skill gaming tournament. In embodiments, if these members join the online skill gaming platform, these new members become network affiliates (Level 1 networks) of the enhanced members. In embodiments, relationships between enhanced members and/or enhanced members network affiliates may be stored in an online skill gaming core server (e.g., an online skill gaming commission server 184). In embodiments, if the online skill gaming tournament is awarding cash prizes, game players may be required to join an online skill gaming platform in order to receive cash payouts. This may be due to governmental regulations.

In embodiments, an online skill gaming tournament may be played or executed 455 (e.g., computer-readable instructions executable by one or more processors of an online skill gaming application server (e.g., a game engine) may initiate playing of the game). In embodiments, an online skill gaming tournament may be completed and/or winners (and/or prize winners) may be determined by an online skill gaming application server or other online skill gaming core servers. In embodiments, an online skill gaming system 100 may not transfer and/or communicate online skill gaming tournament commissions to enhanced member's accounts until a tournament has been completed. In embodiments, for example, players may not play an online skill game at a same time. Thus, in an online skill gaming tournament which have 5 payers, an online skill gaming system may not distribute commissions until all 5 players have completed an online skill gaming tournament game (e.g., a selected online skill gaming tournament game).

In embodiments, after an online skill gaming tournament has completed, computer-readable instructions executable by one or more processors of an online gaming application server (or other online skill gaming core server) may distribute 460 prize money (e.g., virtual prize money) to prize winning member accounts located in a payment server (or an online skill gaming application server). In FantaZ's online skill gaming system, virtual prize money may be transferred to a prize winning member's virtual wallet.

In embodiments, after an online skill gaming tournament has completed, computer-readable instructions executable by one or more processors of an online gaming application server (or other core servers) may distribute 465 online gaming system company's portion of the entry fees to an online skill gaming company's account. In embodiments, money (e.g., virtual money) may be distributed to Fanta-Z Holding's corporate account. In embodiments, for example, 5% of entry fees may be transferred to Fanta-Z Holding's corporate bank account (or virtual account on FantaZ's payment server, database, etc.).

In embodiments, after an online skill gaming tournament has completed, computer-readable instructions executable by one or more processors of an online gaming application server (or other online skill gaming core servers) may distribute 470 enhanced member's commissions to enhanced member's accounts in an online skill gaming commission server 184 server and/or payment server 182 (or other core servers such as an online skill gaming web application server or database server). In embodiments, with FantaZ monetary distribution of commissions for FantaZ enhanced members (e.g., ZBOs) may be communicated/transferred to FantaZ ZBOs virtual wallets in an online skill gaming payment server 182 and/or commission server 182. In embodiments, if an enhanced member is not commissioned qualified (e.g., has not met requirements set by online skill gaming company), payments and/or commission distributions may be transferred to an escrow account for an enhanced member (which may be located on an online skill gaming payment server 182 and/or commission server 182). In embodiments, once an enhanced member becomes commission qualified, online skill gaming payments and/or commission distributions may be communicated to an enhanced member's virtual or actual account in an online skill gaming payment server 184 and/or commission server. In embodiments, if after a specified prior of time, an enhanced member does not become commission qualified, online skill gaming payments and/or commission distributions may be transferred to a sponsor (e.g., upline affiliate or enhanced member who got non-commission qualified to join online skill gaming system 100. In embodiments (% of distribution for each network level may be divided up between qualified Members (enhanced members) at each level with respect to a skill gaming tournament sponsor, host and/or establisher.

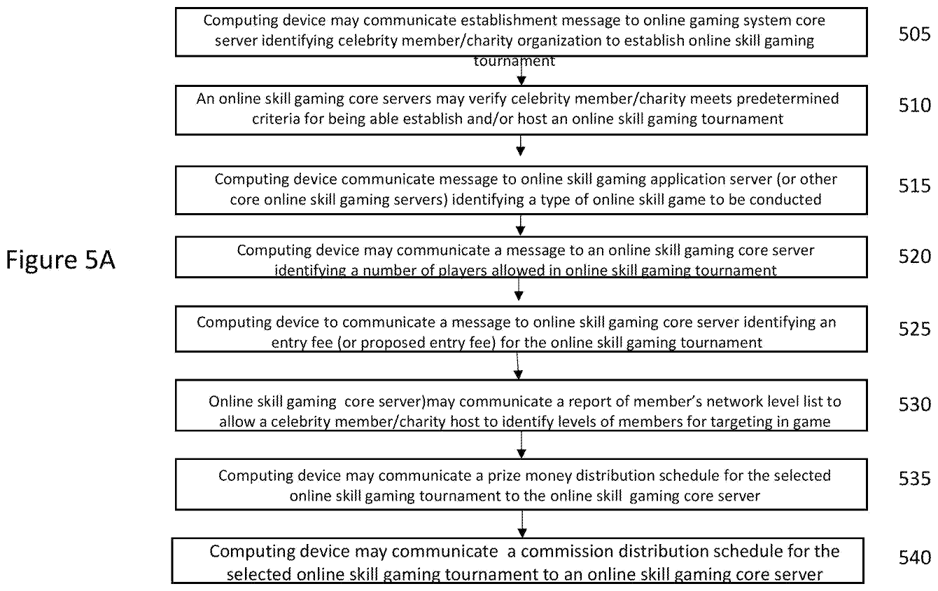

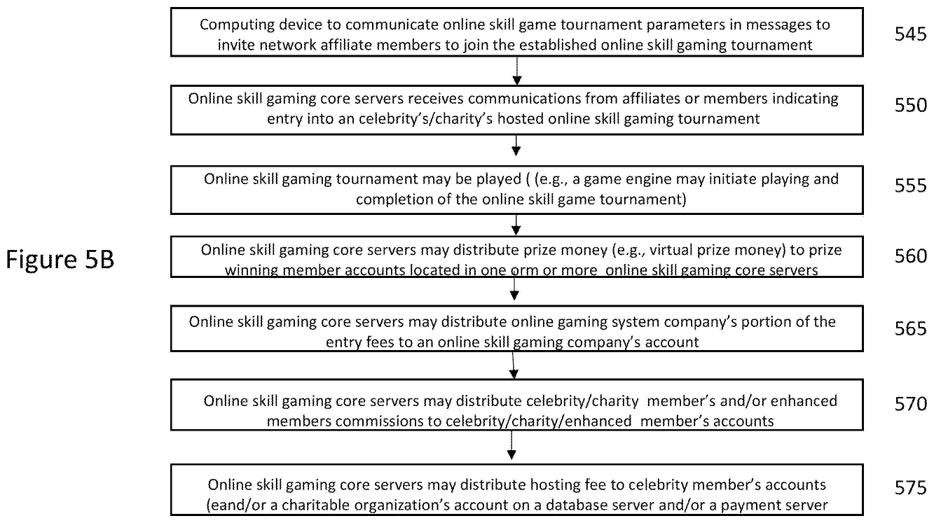

FIG. 5A illustrates a method and/or process for a charitable organization and/or celebrity member establishing an online gaming tournament according to embodiments. FIG. 5B illustrates a method and/or process for a charitable organization and/or celebrity member establishing an online gaming tournament according to embodiments. In embodiments, computer-readable software on a mobile communication device and/or computing device may communicate 505 a game setup/establishment message to an online gaming system application server identifying that a celebrity member and/or a charitable organization would like to establish an online skill gaming tournament (e.g., online skill games and/or online skillified versions of other existing online games). In embodiments, an online skill gaming tournament may be a private tournament or a public tournament). In embodiments, a celebrity member and/or a charitable organization may need to be authenticated and/or verified in order to initiate or establish an online skill gaming tournament. In embodiments, computer-readable instructions executable by a processor of an online skill gaming system application server (or other online skill gaming core servers) may verify 510 that a celebrity member and/or charitable organization meets predetermined criteria for being able to define, establish and/or host an online skill gaming tournament. In embodiments, if an enhanced member is verified, an enhanced member's computing device and/or mobile communications device may initiate communicating messages to an online skill gaming application server to set game rules and/or proceed distributions for the online skill gaming tournament.

In embodiments, for example, a celebrity member's (or charitable organization's computing device (or mobile communications device) may communicate a message to an online skilling gaming application server (or other core online skill gaming servers) identifying a type 515 of skill game to be conducted and/or also whether the skill gaming tournament may be public and/or private. In embodiments, a type of skill game may include a skillified version of existing online games and/or other online skill games. In embodiments, for example, a celebrity member's (or charitable organization's) computing device (or mobile communications device) may communicate a message to an online skill gaming application server identifying a number of players 520 (or proposed number of players) allowed in the skill gaming tournament. In embodiments, for example, a celebrity member's (or charitable organization's) computing device (or mobile communications device) may communicate a message to an online skill gaming application server identifying an entry fee 525 (or proposed entry fee) for the online skill gaming tournament. In embodiments, optionally, an online skill gaming application server (or other core online skill gaming server) may communicate a report and/or measurements of a member's network level list to allow a celebrity member (or charitable organization) (who established the tournament) to identify levels of members who may be targeted 530 in the online skill gaming tournament. In embodiments, computer-readable instructions executable by a processor may perform analysis on the member network level list to identify targeted levels of members. For example, a member's network level list may identify that the member has 5 affiliates at level 1, 10 affiliates at level 2, 25 affiliates at level 3, 250 affiliates at level 4 and 10 affiliates each at levels 5-8. In embodiments, computer-readable instructions executable by a processor may identify that levels 1-4 (and especially level 4) should be targeted and that levels 5-8 are not as important to an enhanced member.

In embodiments, an online skill gaming system may allow authenticated enhanced celebrities and/or charitable organizations to determine and/or selected prize money distribution for an online skill gaming tournament that they may initiate and/or establish. In embodiments, unlike prior compensation systems, an online skill gaming system may allow authenticated enhanced celebrities and/or charitable organizations to establish network level commission distributions as well as distributions within network levels for an online skill gaming tournament. In addition, an online skill gaming system may allow authenticated enhanced celebrities and/or charitable organizations to establish commission distributions within levels. In embodiments, an online gaming system company may set pool distributions (e.g., bonus distributions) for hosts (e.g., celebrities and/or charitable organizations). In embodiments, an online skill gaming company may allow authenticated enhanced celebrities and/or charitable organizations to participate in and/or select distribution of revenue host pool distribution available for enhanced members.

In embodiments, an authenticated enhanced celebrities and/or charitable organizations may select and communicate (utilizing a mobile communications device and/or computing device) a prize money distribution schedule 535 for the selected online skill gaming tournament to the online skill gaming web application server (or other core online skill gaming server). In embodiments, for example, an authenticated celebrity member and/or an authenticated charitable organization may select that only 1st and 2nd place may be awarded with 50% going to first place and 15% going to second place. In embodiments, 5% of a remaining portion of game entry fees may go to an online skill gaming company (game provider) (e.g., FantaZ-Holdings Corporation). In embodiments, 30% of a remaining portion of game entry fees may be selected for commission distributions. In embodiments, an online skill gaming company may have preset prize money distributions that are available for online skill gaming tournaments. In other words, an online skill gaming company (e.g., FantaZ Holdings) may establish that set guidelines for how prize money should be distributed.

In embodiments, an authenticated celebrity member (and/or charitable organization) may select and/or communicate (via a mobile communications device and/or a computing device) a commission distribution schedule 540 for the selected online skill gaming tournament to an online skill gaming web application server or other core online skill gaming server. In embodiments, for example, an authenticated celebrity member (and/or charitable organization) (who is hosting the online skill gaming tournament) may determine a number of network levels to which commissions may be distributed. In embodiments, for example, an authenticated celebrity member (and/or charitable organization) may select that four network levels of affiliates may receive distributed commissions for the selected online skill gaming tournament. In embodiments, an authenticated celebrity member (and/or charitable organization) may also determine which levels (e.g., network levels) receive which percentage of the commission distributions. In embodiments, for example, if four network levels of affiliates are paid commissions, an authenticated celebrity member (and/or charitable organization) may select that network level 1 members may receive 10% of available commission distributions for the online skill gaming tournament, network level 2 members may receive 10% of available commission distributions, network level 3 members may receive 10% of available commission distributions and network level 4 members may receive 70% of available commission distributions. This is a significant improvement on past commission structures. In past commission structures, a set number of network levels received commission distributions. Further, each network level received the same and/or a fixed percentage of commission distributions (e.g., 12.5 percent per network level). This provided a rigid commission structure and online game an authenticated celebrity member (and/or charitable organization) would not be incentivized to participate in and/or promote games. Utilizing the present embodiment, an authenticated celebrity member (and/or charitable organization) may establish and/or setup a commission structure that incentivizes different network levels to promote the online skill gaming tournament. In embodiments, for example, utilizing the example provided above, where a large number of affiliates are at a level 4 downline from the authenticated celebrity and/or charitable organization, it makes sense to establish a commission distribution schedule to provide an incentive to level 4 network affiliates/partners to join in and/or promote the selected online skill gaming tournament.

In embodiments, an online skill gaming system may establish minimum and/or standard commission distribution schedules (e.g., identify how many network levels may receive commission distributions and what percentage of commission distributions may be assigned to each network level. In other words, in FantaZ online skill gaming, a FantaZ authenticated celebrity member (and/or charitable organization) may selects levels of affiliates for payout (How many levels of downline will receive commissions). Further, in embodiments, a FantaZ authenticated celebrity member (and/or charitable organization) may select division of proceeds between levels of affiliates (what percentage does each level in member's downline receives). In other words, an authenticated celebrity member (and/or charitable organization) who is able to define a number of levels to which the uni-level commission is paid out along with a payout percentage for each level. In embodiments, a total amount of uni-level commission may be established and/or predefined by an online skill gaming company and/or provider (e.g., FantaZ Holdings) of an online skill gaming tournament based on the entry fee and a total number of players. In embodiments, an online skill gaming company and/or provide may also define a minimum number of players that need to pay an entry fee and join a game before an online skill gaming tournament may pay commissions out.

In embodiments, revenue from an online skill game tournament entry fees may also be distributed to an authenticated celebrity member (and/or charitable organization) as a game hosting fee. In embodiments, an online skill gaming company may set and/or establish an online skill gaming hosting fee. In embodiments, an authenticated celebrity member (and/or charitable organization) may select and/or communicate a desired hosting fee for the selected online skill gaming tournament to the online skill gaming company via one of the online skill gaming core severs (e.g., a web application server or a commission server or a payment server. In embodiments, for example, a hosting fee may be paid to an authenticated celebrity member (and/or charitable organization) (e.g., a 1% or 2% hosting fee). In embodiments, an online skill gaming tournament may pay a hosting fee to an authenticated celebrity member (and/or charitable organization) if an authenticated celebrity member (and/or charitable organization) has met certain milestones, authentication procedures, matches an online skill game provider's charitable outreach goals and/or targets established by an online skill gaming tournament (in FantaZ online skill gaming this enhanced member may be referred to as a Pro and/or Expert member).

In embodiments, an online skill gaming system application server (or other online skill gaming core servers) may communicate selected online skill game tournament parameters to an authenticated celebrity member and/or charitable organization for verification. In embodiments, an authenticated celebrity and/or charitable organization may utilize computer-readable instructions executed by a mobile communications device and/or computing device to communicate online skill game tournament parameters in messages to network affiliates to invite 545 network affiliate members to join the established online skill gaming tournament (which may also be referred to as a private and/or public online skill gaming tournament). In embodiments, invitations may be communicated via online social media platforms (e.g., Instagram, Facebook, or Twitter) alone and/or in conjunction with the online skill gaming core servers (e.g., the online skill gaming application server, database server, payment server and/or compensation server. In embodiments, invitation messages and/or communications may include private and/or online skill gaming tournament parameters such as Entry Fee, Prize Money Potential (or Life Experience potential), Commission Distribution to Celebrity Members and/or Charitable Organizations, and/or hosting fee to celebrity members and/or charitable organizations. In embodiments, messages may include an enhanced member's online skill gaming URL which may provide easy access to joining the advertised online skill gaming tournament. In embodiments, an authenticated celebrity and/or charitable organization members may only communicate messages to their direct network affiliates (e.g., Level 1) and/or targeted new FantaZ members who are not affiliated with any other celebrity members. In embodiments, additional members may be targeted because an authenticated celebrity member's and/or charitable organization's affiliate may invite their network affiliates who may then invite their network affiliates. In embodiments, if authenticated celebrity members and/or charitable organizations have received pre-approval from an online gaming company, invitation messages may be communication from an online skill gaming application server to all or a large percentage of online skill gaming system members to join an established game. This may be advantageous for specific charity events, e.g., such as hurricane relief fundraising and/or cancer research fundraising.

In embodiments, an online skill gaming system application server (or other online skill gaming core servers) receives 550 communications from affiliates and/or online skill gaming system members indicating entry into an authenticated celebrity member's and/or charitable organization's established online skill gaming tournament. In embodiments, an online skill gaming system application server may also receive payment information which may be communicated and/or transferred to a third party payment processing system for authentication that the potential skill gaming player has made an acceptable payment. In embodiments, an online skill gaming system 100 may further comprise a payment server (e.g., or virtual payment server) 182. In embodiments, online skill gaming system members, celebrity members and/or charitable organizations may have payment accounts established (e.g., on a payment server and/or an online skill gaming application server and/or other online skill gaming core servers) and thus may have virtual currency. In embodiments, the virtual currency may be utilized for entry fees in joining an online skill gaming tournament. In FantaZ online skill gaming system, this may be referred to as a virtual wallet. In embodiments, network affiliates, affiliates of network affiliates and affiliates of affiliates of network affiliates (and so on) may join the established online skill gaming tournament. In embodiments, invited players who are not members on an online skill gaming platform may be invited to join the platform in order to enter the online skill gaming tournament. In embodiments, if these members join the online skill gaming platform, these new members become network affiliates (Level 1 networks) of the celebrity members and/or charitable organizations. In embodiments, if the celebrity members and/or charitable organizations receive pre-approval, any invited online skill gaming system member may join the online skill gaming tournament. In embodiments, if the online skill gaming tournament is awarding cash prizes, game players may be required to join an online skill gaming platform in order to receive cash payouts. This may be due to governmental regulations.

In embodiments, an online skill gaming tournament may be played or executed 555 (e.g., computer-readable instructions executable by one or more processors of an online skill gaming application server (e.g., a game engine) may initiate playing of the game). In embodiments, an online skill gaming tournament may be completed and/or winners (and/or prize winners) may be determined by an online skill gaming application server (or other online skill gaming core servers). As discussed previously, prize money, bonus or pool money, or commissions may not be distributed until an online skill gaming tournament has been completed. Also, as discussed previously, an enhanced member must be commission qualified in order to receive commission distributions.

In embodiments, after an online skill gaming tournament has completed, computer-readable instructions executable by one or more processors of an online gaming application server (or other online skill gaming core servers) may distribute 560 prize money (e.g., virtual prize money) to prize winning member accounts located in a payment server (or in an online skill gaming application server or other online skill gaming core servers). In FantaZ's online skill gaming system, virtual prize money may be transferred to a prize winning member's virtual wallet.

In embodiments, after an online skill gaming tournament has completed, computer-readable instructions executable by one or more processors of an online gaming application server (or other online skill gaming core servers) may distribute 565 online gaming system company's portion of the entry fees to an online skill gaming company's account. In embodiments, money (e.g., virtual money) may be distributed to Fanta-Z Holding's corporate account. In embodiments, for example, 5% of entry fees may be transferred to Fanta-Z Holding's corporate bank account (or virtual account on FantaZ's payment server, database server, etc.).

In embodiments, after an online skill gaming tournament has completed, computer-readable instructions executable by one or more processors of an online gaming application server (or other online skill gaming core servers) may distribute 570 celebrity member's (and/or charitable organization's and/or enhanced member's (e.g., ZBOs) commissions to celebrity member's (and/or charitable organization's and/or enhanced member's) accounts in a payment server (or an online skill gaming web application server or database server). In embodiments, for example, FantaZ monetary distribution of commissions may be transferred to celebrity member's virtual wallets, charitable organization's virtual wallets and/or enhanced members (e.g., ZBOs) to FantaZ ZBOs virtual wallets. In embodiments (% of distribution for each network level may be divided up between qualified Members (enhanced members) at each network level with respect to a skill gaming tournament sponsor, host and/or establisher.

In embodiments, after an online skill gaming tournament game play has been completed, computer-readable instructions executable by one or more processors of an online gaming application server (or other online skill gaming core servers) may distribute 575 a hosting fee (if applicable) to celebrity member's accounts (e.g., virtual wallets) and/or a charitable organization's account on one or more online skill gaming core servers (e.g., a database server, commissions or compensation server, and/or a payment server).

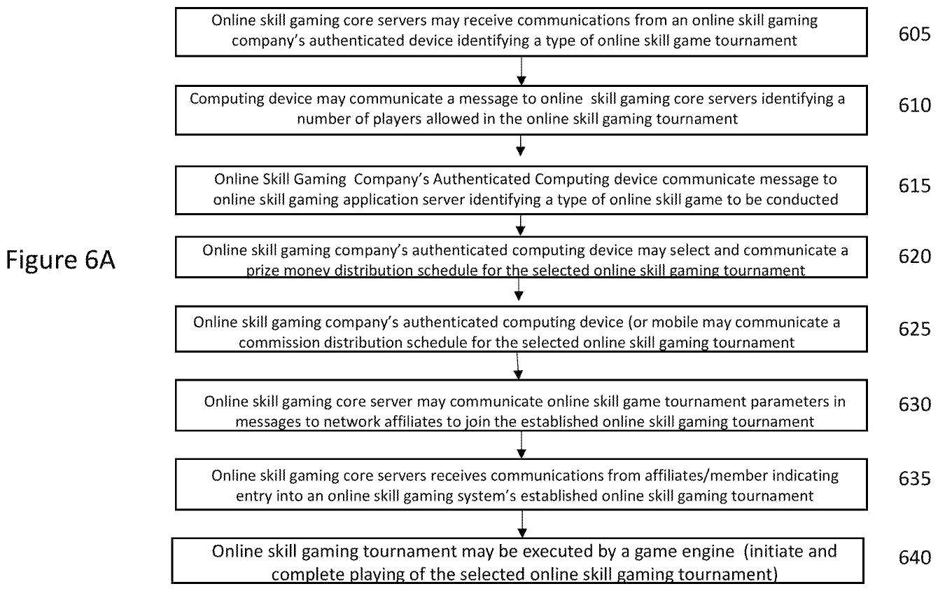

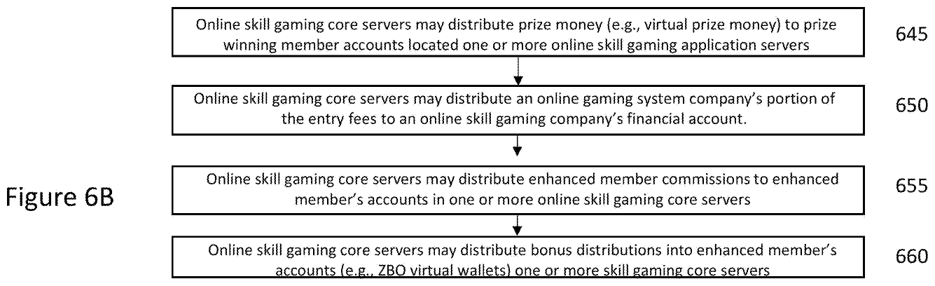

FIG. 6— FantaZ establishes game. FIG. 6A illustrates a computer-implement method and/or process for establishment and execution on an online skill gaming tournament by an online skill gaming entity according to embodiments. FIG. 6B illustrates a computer-implement method and/or process for establishment and execution on an online skill gaming tournament by an online skill gaming entity according to embodiments. In embodiments, for example, computer-readable instructions executed by a processor on an online skilling gaming application server (or other online skill gaming core servers) may receive communications from an online skill gaming company's authenticated device identifying a type 605 of online skill game tournament to be conducted and/or also whether the online skill gaming tournament may be public and/or private. In embodiments, a type of skill game may include skillified versions of card games or other online games, and/or other online skill games. In embodiments, an online skill gaming company's authenticated device is a computing device and/or mobile communication device either owned, operated, and/or authorized by an online skill gaming company (e.g., a computing device and/or mobile communication device authorized, owner and/or operated by FantaZ personnel and/or employees). In embodiments, for example, an online skill gaming company's authenticated computing device (or mobile communications device) may communicate a message to an online skill gaming application server (or other online skill gaming core servers) identifying a number of players 610 (or proposed number of players) allowed in the online skill gaming tournament. In embodiments, for example, an online skill gaming company's authenticated computing device (or mobile communications device) may communicate a message to an online skill gaming application server identifying an entry fee 615 (or proposed entry fee) for the online skill gaming tournament.

In embodiments, an online skill gaming company's authenticated computing device (or mobile communications device) may select and communicate a prize money distribution schedule 620 for the selected online skill gaming tournament to the online skill gaming web application server (or other online skill gaming core server). In embodiments, for example, an online skill gaming company's authenticated computing device (or mobile communications device) may select that only 1st place may be awarded with 50% of proceeds going to a first place prize. In embodiments, 15% of a remaining portion of game entry fees may go to an online skill gaming company (game provider) (e.g., FantaZ-Holdings Corporation). In embodiments, 35% of a remaining portion of game entry fees may be selected for commission distributions.

In embodiments, an online skill gaming company's authenticated computing device (or mobile communications device) may select and/or communicate a commission distribution schedule 625 for the selected online skill gaming tournament to an online skill gaming web application server (or other online skill gaming core server). In embodiments, for example, an online skill gaming company (who is hosting the online skill gaming tournament) may determine a number of network levels to which commissions may be distributed. In embodiments, for example, an online skill gaming company's authenticated computing device (or mobile communications device) may select that three network levels of affiliates may receive distributed commissions for the selected online skill gaming tournament. In embodiments, an online skill gaming company's authenticated computing device (or mobile communications device)) may also determine which levels (e.g., network levels) receive which percentage of the commission distributions. In embodiments, for example, if three network levels of affiliates are paid commissions, an online skill gaming company's authenticated computing device may select that network level 1 members may receive 20% of available commission distributions for the online skill gaming tournament, network level 2 members may receive 40% of available commission distributions and network level 3 members may receive 40% of available commission distributions.

In embodiments, revenue from an online skill game tournament entry fees may also be distributed to enhanced member bonus pools. If enhanced members have reached certain milestones and/or requirements, an enhanced member (e.g., such as a FantaZ ZBO Expert and/or Pro) may be eligible for enhanced member bonus pools. In embodiments, an online skill gaming company's authenticated computing device (or mobile communications device) may select and/or communicate a percentage of received revenue is available for enhanced member bonus pools for the selected online skill gaming tournament to the online skill gaming web application server (or other online skill gaming core server). In embodiments, for example, a percentage to be set aside for bonus pools may be, for example, 1% to 3%.

In embodiments, computer-readable instructions executable by one or more processors by an online skill gaming application server (or other online skill gaming core server) may communicate online skill game tournament parameters in messages to network affiliates to invite 630 network affiliate members to join the established online skill gaming tournament (which may also be referred to as a private and/or public online skill gaming tournament). In embodiments, invitations may be communicated via online social media platforms (e.g., Instagram, Facebook, or Twitter) alone and/or in conjunction with the online skill gaming application server (or other online skill gaming core servers). In embodiments, invitation messages may comprise an online skill gaming company's URL to make it easy for members to join an online skill gaming tournament. In embodiments, invitation messages and/or communications may include private and/or online skill gaming tournament parameters such as Entry Fee, Prize Money Potential (or Life Experience potential), Commission Distribution to Enhanced Members, and/or Enhanced Member bonus awards. In embodiments, an online skill gaming company's authenticated computing device (or mobile communications device) may only communicate messages to direct network affiliates (e.g., Level 1) and/or targeted new FantaZ members who are not affiliated with any other enhanced members.

In embodiments, an online skill gaming system application server (or other online skill gaming core servers) receives 635 communications from affiliates and/or online skill gaming system members (e.g., computing devices) indicating entry into an online skill gaming system's established online skill gaming tournament. In embodiments, an online skill gaming system application server (or other online skill gaming core servers) may also receive payment information which may be communicated and/or transferred to a third party payment processing system for authentication that the potential skill gaming player has made an acceptable payment. In embodiments, an online skill gaming system may further comprise a payment server (e.g., or virtual payment server). In embodiments, online skill gaming system members may have payment accounts established (e.g., on a payment server and/or an online skill gaming application server or other online skill gaming core server)) and thus may have virtual currency. In embodiments, the virtual currency may be utilized for entry fees in joining an online skill gaming tournament established by an online skill gaming company. In FantaZ online gaming system, this may be referred to as a virtual wallet. In embodiments, network affiliates, affiliates of network affiliates and affiliates of affiliates of network affiliates (and so on) may join the established online skill gaming tournament. In embodiments, invited players who are not members on an online skill gaming platform may be invited to join the platform in order to enter the online skill gaming tournament. In embodiments, if these members join the online skill gaming platform, these new members become network affiliates (Level 1 networks) of the online skill gaming company (e.g., FantaZ).

In embodiments, an online skill gaming tournament may be played or executed 640 (e.g., computer-readable instructions executable by one or more processors of an online skill gaming application server (e.g., a game engine) may initiate playing of the game). In embodiments, an online skill gaming tournament may be completed and/or winners (and/or prize winners) may be determined by an online skill gaming application server (and/or other online skill gaming core servers).

In embodiments, after an online skill gaming tournament has completed, computer-readable instructions executable by one or more processors of an online gaming application server (or other online skill gaming core servers) may distribute 645 prize money (e.g., virtual prize money) to prize winning member accounts located in a payment server (or in an online skill gaming application server). In FantaZ's online skill gaming system, virtual prize money may be transferred to a prize winning member's virtual wallet.

In embodiments, after an online skill gaming tournament has completed, computer-readable instructions executable by one or more processors of an online skill gaming application server (or other online skill gaming core servers) may distribute 650 an online gaming system company's portion of the entry fees to an online skill gaming company's account. In embodiments, money (e.g., virtual money) may be distributed to Fanta-Z Holding's corporate account. In embodiments, for example, 5-10% of entry fees may be transferred to Fanta-Z Holding's corporate bank account (or virtual account on FantaZ's payment server, database server, or other FantaZ core servers etc.).

In embodiments, after an online skill gaming tournament has completed, computer-readable instructions executable by one or more processors of an online skill gaming application server (or other online skill gaming core server) may distribute 655 enhanced members (e.g., ZBOs) commissions to enhanced member's accounts in a payment server (or an online skill gaming web application server or database server or other online skill gaming core server). In embodiments, for example, FantaZ monetary distribution of commissions may be transferred to enhanced members (e.g., FantaZ ZBOs) virtual wallets. In embodiments (% of distribution for each network level may be divided up between qualified Members (enhanced members) at each network level with respect to an online skill gaming tournament sponsor, host and/or establisher.

In embodiments, after an online skill gaming tournament game play has been completed, computer-readable instructions executable by one or more processors of an online gaming application server (or other online skill gaming core servers) may distribute 660 bonus distributions into enhanced member's accounts (e.g., ZBO virtual wallets) on a database server and/or a payment server or other online skill gaming core servers.

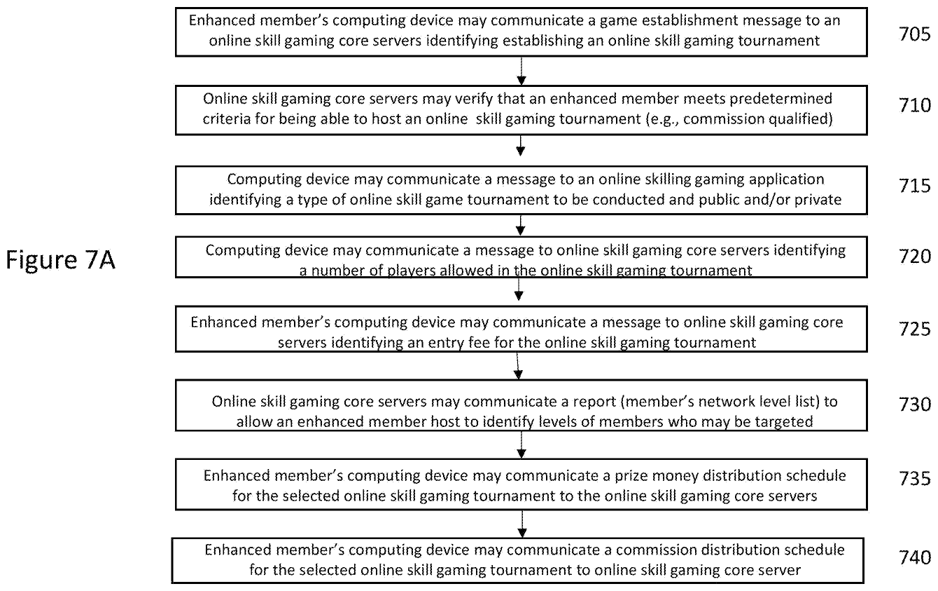

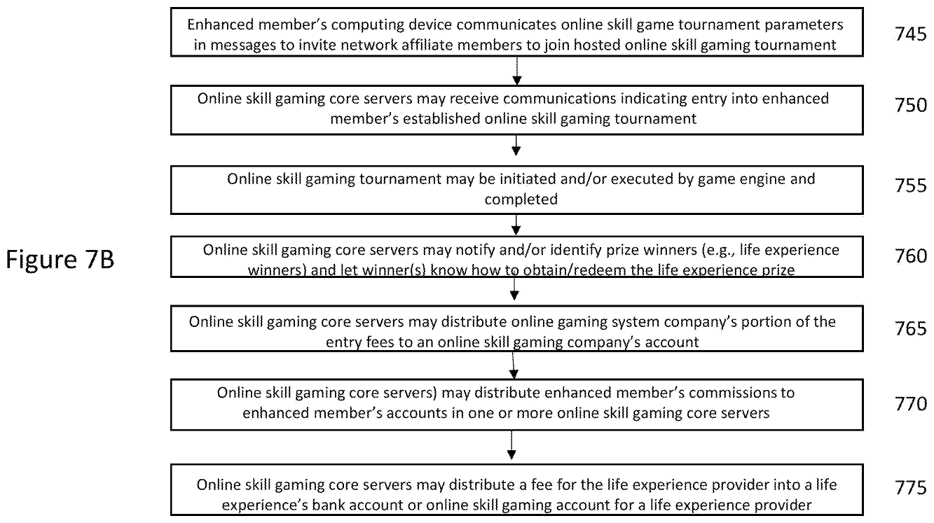

FIG. 7A illustrates an enhanced member setting up and establishing an online skill game where a prize may be a life experience according to embodiments. FIG. 7B illustrates an enhanced member setting up and establishing an online skill game where a prize may be a life experience according to embodiments. In embodiments, a life experience may be a golf tournament with an enhanced member, a football game experience with an ex-player, a backstage pass to a concert, and/or a trip to an exotic vacation local. In embodiments, an online skill gaming company may need to approve and authorize all online skill game tournament distributions and requirements in order to verify that certain rules are followed and any governmental regulations may be followed. In embodiments, an online skill gaming company may be FantaZ Holdings.

In embodiments, computer-readable software executable on one or more processors on a mobile communication device and/or computing device may communicate 705 a game setup/establishment message to an online skill gaming system application server (or one or more other online skill gaming core servers) identifying that an enhanced member would like to establish a tournament (e.g., may be a private or public tournament). In embodiments, an enhanced member may need to be commissioned qualified to initiate or establish an online skill gaming tournament. In embodiments, computer-readable instructions executable by a processor of an online skill gaming system application server (or one or more other online skill gaming core servers) may verify 710 that an enhanced member meets predetermined criteria for being able to define and/or host a skill gaming tournament (e.g., commission and/or life experience qualified). In embodiments, if an enhanced member is verified, an enhanced member's computing device and/or mobile communications device may initiate communicating messages to an online skill gaming application server (or one or more other online skill gaming core servers) to set game rules and/or game distributions for the skill gaming tournament.

In embodiments, for example, an enhanced member's computing device (or mobile communications device) may communicate a message to an online skill gaming application server (or one or more other online skill gaming core servers) identifying a type 715 of skill game to be conducted and/or also whether the online skill gaming tournament may be public and/or private. In embodiments, for example, an enhanced member's computing device (or mobile communications device) may communicate a message to an online skill gaming application server (or one or more other online skill gaming core servers) identifying a number of players 720 allowed in the online skill gaming tournament. In embodiments, for example, an enhanced member's computing device (or mobile communications device) may communicate a message to an online skill gaming application server (or one or more other online skill gaming core servers) identifying an entry fee 725 for the online skill gaming tournament.

In embodiments, optionally, an online skill gaming application server (or one or more other online skill gaming core servers) may communicate a report and/or measurements of a member's network level list to allow an enhanced member (who established the tournament) to identify levels of members who may be targeted 730 in the online skill gaming tournament. In embodiments, computer-readable instructions executable by a processor may perform analysis on the member network level list to identify targeted levels of members.

In embodiments, an enhanced member (e.g., mobile computing device or computing device) may select and communicate a prize money distribution schedule 735 for the selected online skill gaming tournament to the online skill gaming web application server (or one or more other online skill gaming core servers). In embodiments, for example, an enhanced member may select that one or more life experiences may be awarded to winning game player(s) be distributed up to 50% out of the proceeds. In embodiments, 20% of a remaining portion of game entry fees may go to an online skill gaming company (game provider) (e.g., FantaZ-Holdings corporation). In embodiments, up to 80% of a remaining portion of game entry fees may be selected for commission distributions. In life experience prize-based online skill games, there is an opportunity for a higher level of money to be distributed to enhanced members. In embodiments, a percentage of entry fees may be awarded as a hosting and/or establishment fee to the enhanced member providing the life experience and/or who established the online skill gaming tournament. In embodiments, a percentage of entry fees may be awarded to bonus pools for qualified and/or authenticated enhanced members who has met certain milestones and/or requirements.

In embodiments, an enhanced member (via a mobile communications device or mobile computing device, or a computing device) may select and/or communicate a commission distribution schedule 740 for the selected online skill gaming tournament to the online skill gaming web application server (or one or more other online skill gaming core servers). In embodiments, for example, an enhanced member (who is hosting the online skill gaming tournament) may determine a number of network levels to which commissions are to be distributed. In embodiments, for example, an enhanced member may select that four network levels of affiliates may receive distributed commissions for the selected online skill gaming tournament. In embodiments, may also determine which levels (e.g., network levels) receive which percentage of the commission distributions, as is described above with respect to FIGS. 4, 5 and 7.

In embodiments, an online skill gaming system application server (or one or more online skill gaming core servers) may communicate selected online skill game tournament parameters to an enhanced member for verification. In embodiments, an enhanced member may utilize computer-readable instructions executed by a mobile communications device and/or computing device to communicate online skill game tournament parameters in messages to network affiliates to invite 745 network affiliate members to join the established online skill gaming tournament (which may also be referred to as a private online skill gaming tournament). In embodiments, invitations may be communicated via online social media platforms (e.g., Instagram, Facebook, or Twitter) alone and/or in conjunction with the online skill gaming application server. In embodiments, an enhanced member's URL may be included in an invitation message to allow for easy entry into an online skill gaming tournament. In embodiments, invitation messages and/or communications may include private online skill gaming tournament parameters such as Entry Fee, Life Experience potential, commission distribution to enhanced members. In embodiments, an enhanced members may only communicate messages to their direct network affiliates (e.g., Level 1) and/or targeted new FantaZ members who are not affiliated with any enhanced members. In embodiments, additional members may be targeted because an enhanced member's affiliate may invite their network affiliates who may then invite their network affiliates.

In embodiments, an online skill gaming system application server (or one or more other online skill gaming core servers) may receive 750 communications indicating entry into enhanced member's established online skill gaming tournament. In embodiments, an online skill gaming system application server (or one or more other online skill gaming core servers) may also receive payment information which may be communicated and/or transferred to a third party payment processing system for authentication that the potential skill gaming player has made an acceptable payment. In embodiments, an online skill gaming system may further comprise a payment server (e.g., or virtual payment server). In embodiments, online skill gaming system members and/or enhanced members may have payment accounts established (e.g., on a payment server) and thus may have virtual currency. In embodiments, the virtual currency may be utilized for entry fees in joining an online skill gaming tournament. In FantaZ online gaming system, this may be referred to as a virtual wallet. In embodiments, network affiliates, affiliates of network affiliates and affiliates of affiliates of network affiliates (and so on) may join the established online skill gaming tournament. In embodiments, invited players who are not members on an online skill gaming platform may be invited to join the platform in order to enter the online skill gaming tournament. In embodiments, if these members join the online skill gaming platform, these new members become network affiliates (Level 1 networks) of the enhanced members. In embodiments, if the online skill gaming tournament is awarding cash prizes, game players may be required to join an online skill gaming platform in order to receive a life experience prize.

In embodiments, an online skill gaming tournament may be played or executed 755 (e.g., computer-readable instructions executable by one or more processors of an online skill gaming application server (e.g., a game engine) may initiate playing of the game). In embodiments, an online skill gaming tournament may be completed and/or winners (and/or life experience winners) may be determined by an online skill gaming application server.

In embodiments, after an online skill gaming tournament has completed, computer-readable instructions executable by one or more processors of an online gaming application server (or one or more other online skill gaming core servers) may notify and/or identify 760 prize winners (e.g., life experience winners) and let winner(s) know how to obtain and/or redeem the life experience prize.

In embodiments, after an online skill gaming tournament has completed, computer-readable instructions executable by one or more processors of an online gaming application server (or one or more online skill gaming core servers) may distribute 765 online gaming system company's portion of the entry fees to an online skill gaming company's account. In embodiments, money (e.g., virtual money) may be distributed to Fanta-Z Holding's corporate account. In embodiments, for example, 10% of entry fees may be transferred to Fanta-Z Holding's corporate bank account (or virtual account on FantaZ's payment server, database server, other online skill gaming core servers, etc.).

In embodiments, after an online skill gaming tournament has completed, computer-readable instructions executable by one or more processors of an online gaming application server (or one or more online skill gaming core servers) may distribute 770 enhanced member's commissions to enhanced member's accounts in a payment server (or an online skill gaming web application server or database server or other online skill gaming core servers). In embodiments, with FantaZ monetary distribution of commissions for FantaZ enhanced members (e.g., ZBOs) may be communicated/transferred to FantaZ ZBOs virtual wallets. In embodiments (% of distribution for each network level may be divided up between qualified Members (enhanced members) at each level with respect to a skill gaming tournament sponsor, host and/or establisher. Games with life experiences may generate more commissions and/or more commission distributions to specified network affiliates who played the online skill gaming tournament with the life experience.

In embodiments, after an online skill gaming tournament game play has been completed, computer-readable instructions executable by one or more processors of an online skill gaming application server (or one or more other online skill gaming core servers) may distribute 775 a fee for the life experience provider into a life experience's bank account or online skill gaming account for a life experience provider. In embodiments, a life experience provider may be a ZBO and a provide fee may be placed into the ZBO's virtual wallets on a database server and/or a payment server.

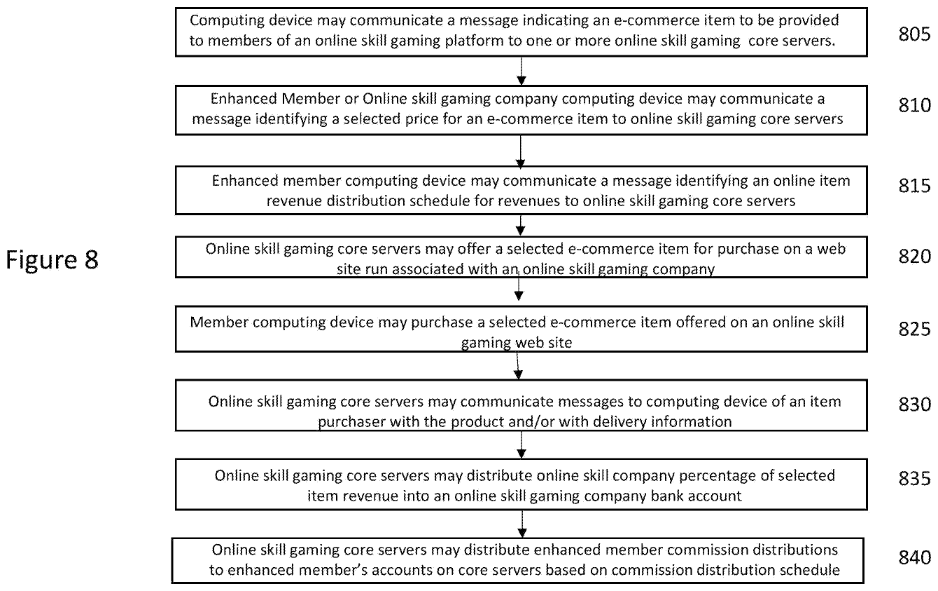

FIG. 8 illustrates selling of goods and services and distribution of commissions on an online skill gaming application server according to embodiments. In embodiments, an enhanced member, via computer-readable instructions executable on a processor of a mobile communication device (or a computing device), may communicate a message indicating an e-commerce item to be provided 805 to members of an online skill gaming platform or system to one or more online skill gaming core servers (e.g., payment server, commissions server, database server, e-commerce server and/or application server. In embodiments, an enhanced member, via computer-readable instructions executable on a processor of a mobile communication device (or a computing device), may communicate a message identifying a selected price 810 for an e-commerce item to one or more online skill gaming core servers (e.g., payment server, commissions and/or compensation server and/or application server). In embodiments, an enhanced member, via computer-readable instructions executable on a processor of a mobile communication device (or a computing device), may communicate a message identifying a revenue distribution schedule 815 for revenues received from sales of a selected item to one or more online skill gaming core servers (e.g., payment server, commissions and/or compensation server, e-commerce server and/or application server. In embodiments, an online skill gaming company may work with and/or authorize enhanced member's sales of e-commerce items.

In embodiments, computer-readable instructions executable by a processor on one or more online skill gaming core servers ((e.g., payment server, commissions and/or compensation server, e-commerce server, and/or application server), may offer 820 a selected e-commerce item for purchase on a web site run associated with an online skill gaming company. In embodiments, online skill gaming players, via computer-readable instructions executable on one or more processors of a mobile communications device (or computing device) may purchase 825 a selected e-commerce item offered on an online skill gaming web site. These purchases may be made in actual money (e.g., via a credit card, checking account, debit card, gift cards) or virtual money (e.g., FantaZ Wallet money). In embodiments, computer-readable instructions executable by one or more processors on one or more online skill gaming core servers (e.g., payment server, e-commerce server, commissions and/or compensation server and/or application server), may offer online skill gaming players an opportunity to join an online skill gaming company's platform. In embodiments, an enhanced member may make joining an online skill gaming company platform a condition for purchasing a selected e-commerce item. In embodiments, an online skill gaming player who joins as a result of an invitation may become network affiliates of a master enhanced member and/or may become network affiliates of an enhanced member who is offering a selected e-commerce item for purchase.

In embodiments, computer-readable instructions executable by a processor on one or more online skill gaming core servers (e.g., payment server, commissions and/or compensation server, e-commerce server, and/or application server), may communicate messages to a mobile communications device or computing device of an item purchaser with the product (e.g., if a downloadable item such as software, virtual prize, and/or token) and/or with delivery information 830 (e.g., if a tangible item or product). In embodiments, computer-readable instructions executable by a processor on one or more online skill gaming core servers (e.g., payment server, e-commerce server, commissions and/or compensation server and/or application server), may distribute 835 an online skill company percentage of selected item revenue into an online skill gaming bank account and/or account on a payment server (e.g., or application server or other core servers). In embodiments, computer-readable instructions executable by a processor on one or more online skill gaming core servers (e.g., payment server, e-commerce server, commissions and/or compensation server and/or application server), may distribute, enhanced member commission distributions 840 to enhanced member's accounts, on a payment server and/or application server, based on an established commission distribution schedule. In embodiments, where an online gaming company is FantaZ, commissions may be distributed and/or transferred into FantaZ virtual wallets. In embodiments, a percentage of distribution for each network level may be divided up between qualified enhanced members at each level.

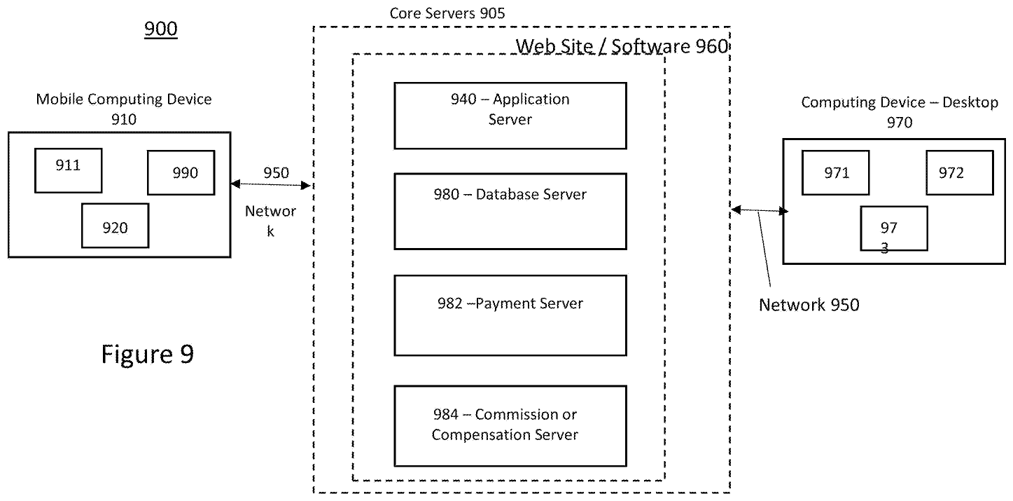

FIG. 9 is a functional block diagram illustrating a distributed data processing environment 100 for use by entities operating in an online environment. In embodiments, an online system 900 (e.g., in a distributed data processing environment) may comprise one or more mobile communications and/or computing devices 910 (or other portable computing devices such as tablets, laptops, network computers, etc.), which may comprise a web content program 911, a container or memory storage for static data or information 920, and/or a browser 990 for interacting with servers in an online environment. In embodiments, desktop and computing device 970 may also comprise a web content program 971, a container or memory storage for static data or information 972, and/or a browser 973 for interacting with servers in an online environment In embodiments, an online system 900 (e.g., in a distributed data processing environment) may also comprise online core servers 905 which operate a web site and/or an intranet site of a company or entity operating online. In embodiments, one or more online skill gaming core servers 905 may comprise a database (or database server) 980, and an application server (e.g., or web server 940), shown hosting computer-readable instructions that may be executed by one or processors on an application server. In embodiments, an online skill gaming system 00 may further comprise a payment serer 982 (or payment processing server) and/or a commission or compensation or commission server 984. In embodiments, a database server 980, an application server 940, a payment server 982 and/or a compensation server 984 may form a core network of servers. In embodiments, such a core network of servers may be resident and/or installed on one physical computing devices (or servers) or more than one physical computing device and/or servers. In embodiments, such a core network of servers may be resident on cloud-based servers. In embodiments, computer-readable instructions may be executable by one or more processors on one or more of the core servers to implement the online skill gaming system 900. In embodiments, computer-readable instructions executable by one or more processors may be referred to as an online skill gaming website 960 (e.g., web application 960) along with static content. In embodiments, an application and/or web server 940, a database and/or database server 980, a payment server 982 and/or a compensation server 984, and/or a mobile computing or communication device 910 may be connected via a communications network 950. In embodiments, online skill gaming core servers may be utilized along with or in place of application server 940, payment server 982, database server 980 and/or commission or compensation server 984.

In embodiments, network 950 may be, for example, a local area network (LAN), a telecommunications network, a wide area network (WAN), such as the Internet, a virtual local area network (VLAN), or any combination that can include wired, wireless, or optical connections. In general, network 950 may be any combination of connections and protocols that may support communications between the applications and components of web and/or application server 940, a database or database application server 980, and the applications and components of mobile computing and/or communications device 910.

In embodiments, an online skill gaming web or application server 940 may be a computing device, a server, a network device, that is not local and/or may be remote to a mobile computing and/or communications device 910. In embodiments, an online skill gaming application server or web server 940 may comprise an online skill gaming web or software application 960, and online skill gaming static content which may be retrieved utilizing a software application. In embodiments, an online skill gaming application server or web server 940 may generate web pages in response to requests to access an online skill gaming website operated by an online skill gaming web or software application 960.

In embodiments, an online skill gaming application server or web server 940, a database server 980, a payment processing server 982 and/or a compensation server 984 (e.g., a core network of servers) may be a management server, a web application server may be resident and/or installed in a blade server, a mobile computing or communications device, a computing device, or other electronic device or computing system capable of receiving and sending data. In embodiments, an online skill gaming application or web server 940, a database server 980, a payment processing server 982 and/or a compensation server 984 (e.g., a core network of servers) may represent a virtual computing device of a computing system utilizing multiple computers as a server system, such as in a cloud computing environment (e.g., or cloud computing servers). In embodiments, an online skill gaming application or web server 940, a database server 980, a payment processing server 982 and/or a compensation server 984 (e.g., a core network of servers) may be installed and/or resident on a laptop computer, a tablet computer, a netbook computer, a personal computer (PC), a desktop computer, a personal digital assistant (PDA), or any programmable electronic device capable of access to a network 950, and performing the operational steps of an online skill gaming software or web application 960. In embodiments, an online skill gaming application or web server 940, a database server 980, a payment processing server 982 and/or a compensation server 984 (e.g., a core network of servers) may represent a computing system utilizing clustered computers and/or components (e.g., database server computers, application server computers, etc.) that act as a single pool of seamless resources when accessed within distributed data processing environment 900. In embodiments, an online skill gaming application or web server 940, a database server 980, a payment processing server 982 and/or a compensation server 984 (e.g., a core network of servers) may include internal and external hardware components (e.g., one or more memory modules, one or more processors, one or more network adapters and/or transceivers, one or more monitors or displays).

In embodiments, an online skill gaming software or web application 160 may include JSPs and/or PHPs, which support a website on an online skill gaming application or web server 940, which may be referred to as an online skill gaming web application server. In embodiments, an online skill gaming software or web application 960 may be accessed by setting up, establishing and/or providing a uniform resource identifier (URI) that corresponds to a website supported by and/or executing an online skill gaming software or web application 960, to an online skill gaming web content program or software application 210 that may be stored and/or resident on a mobile computing and/or communication device 910. A URI may also be classified as a locator, a name, or both, e.g., a term Uniform Resource Locator (URL) may be a type of URI, and refers to the subset of URIs that, in addition to identifying a resource, provide a way or method of locating a resource (e.g., a website) by its network location. For simplicity and consistency, references to accessing or receiving content from a website may refer to a URL, with the understanding that a URL may both identify and locate a website, and thus a URL may correspond to a website. In an online skill gaming system, a URL may be utilized to specifically identify members of the online gaming system. In embodiments, a URL may identify a host address of a member in an online skill gaming system

In embodiments, when accessed by a URL link, an online skill gaming software or web application 960 may generate a web page associated with the particular URL that corresponds to the website. In embodiments, generation of a web page may include references to static content stored on an online skill gaming application or web server 940, and/or dynamic content of an online skill gaming application or web server. In embodiments of the present invention, dynamic content used by an online skill gaming software and/or web application 960 may generate a web page may reside in files stored on an online skill gaming application and/or web server 940, may be accessed from a database or database server 980, a payment processing server 982, and/or a compensation server or may be accessed from other sources and/or databases which may be connected to connected to communications network 950 (not shown). In embodiments, online skill gaming software or web application 960 may dynamically generate a web page associated with a particular URL link when the URL is accessed by another computing device, such as mobile computing and/or communications device 910, and builds the web page each time the URL is accessed, by retrieving and combining dynamic and static content.

In embodiments, static content 170 may include a web page “static resources” that remain constant through multiple builds and displays for multiple users of a web page associated with a particular website. In embodiments, online skill gaming static content 170 may include for example, but are not limited to, cascading style sheets (CSS), formatting content, hypertext markup language (HTML) files, JavaScript, and images associated with a website owned and/or operated by an online skill gaming owner and/or operator. Although online skill gaming static content 170 may be updated, it is characterized by not varying based on the user or entity accessing the web page, or the frequency of accessing the web page, of the website.

In embodiments, an online skill gaming database server or database 980, a payment processing server 982 and/or a compensation server 984 may be a source of data that is used by online skill gaming software or web application 960 to provide dynamic content to a web page generated by an online skill gaming software and/or web application or web site 960 on an online skill gaming web server and/or application server 940, a database server 980, a payment processing server 982 and/or a compensation server 984 (e.g., a core network of servers). In embodiments, an online skill gaming database server and/or database 980 may include, for example, profile or settings data for individual users that access an online skill gaming website that is supported by an online skill gaming software and/or web application 960. The profile or settings data may provide user-specific information, such as name, account number, and status, or may display user preferences, such as language and may include values associated with monetary and/or point values. In some embodiments of the present invention, dynamic content may be accessed from files, tables, or other storage structures, accessible to an online skill gaming software or web application, such as online skill gaming web application 960. In embodiments, a payment processing server 982 may comprise computer-readable instructions executable by one or more processors that handle communications with external payment processing servers, financial institutions, credit or debit card institutions; handle virtual money (e.g., FantaZ wallet transmission); and/or handle communications with other core network servers in an online skill gaming system 900 (e.g., a database server 980, a compensation server 984 and/or an online skill gaming application server 940). In embodiments, a compensation server 984 may comprise computer-readable instructions executable by one or more processors that handle member network compensation accounts, member network affiliate level identification, commission distributions to members, bonus pool distributions to members, and monetary distributions to an online skill gaming company (e.g., FantaZ) normally a bank account.

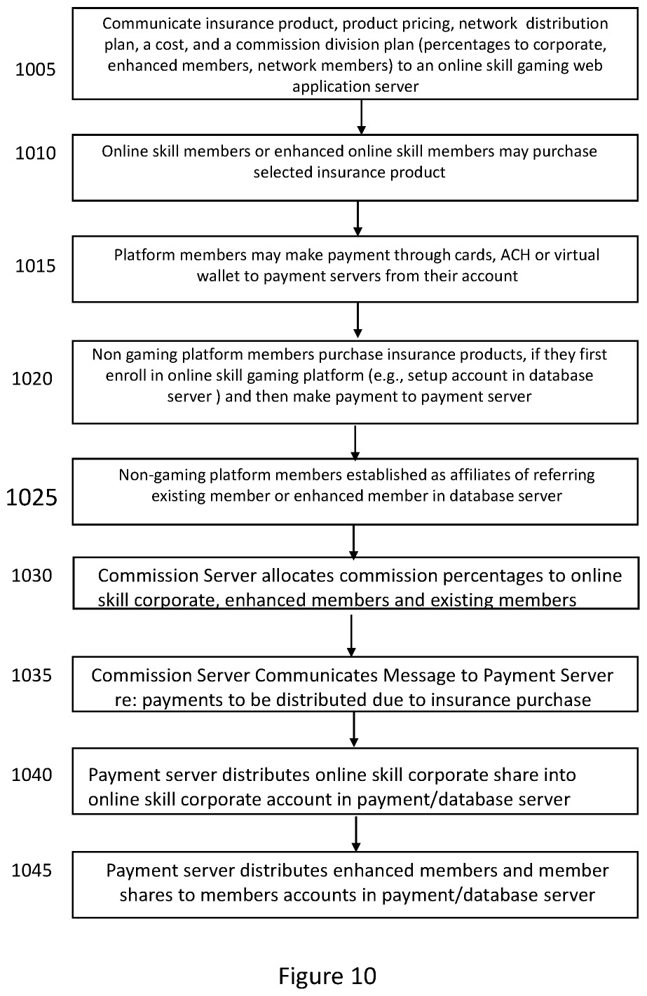

FIG. 10 is a description of compensation systems and methods applied to insurance or annuities market according to some implementations. The methods and systems described above may be utilized in selling products via a variable level marketing process according to some embodiments. For example, life insurance products and/or annuities may be sold utilizing the process described above and/or below. In embodiments, computer-readable software on a mobile communication device 910 and/or computing device 970 may communicate 1005 a message to an online skill gaming system application server 140 or 940 identifying that an insurance or annuity product has been created and/or also specifying a pricing of the insurance or annuity product, a distribution plan for the insurance or annuity product (e.g., which online skill gaming members), a cost of the insurance product, and a variable level commission plan for the insurance or annuity product that may be sold on the online skill gaming system platform or via other computing systems.

In embodiments, this message may be communicated to one or more of a core group of servers (e.g., an application server 140 or 940, a database server 180 or 980, a payment processing server 182 or 982 and/or a compensation server 184 or 984). In embodiments, optionally, an online skill gaming application server may communicate a report and/or parameters of a member's network level list to allow an enhanced member (or others that may be promoting or selling the insurance or annuity product) to identify levels of members who may be targeted or approached to purchase the insurance or annuity product. In embodiments, computer-readable instructions executable by a processor may perform analysis on the member network level list to identify targeted levels of members. For example, a member's network level list may identify that the member has 8 affiliates at level 1, 20 affiliates at level 2, 350 affiliates at level 3, and 10 affiliates each at levels 4-8. In embodiments, computer-readable instructions executable by a processor may identify that members at levels 1-3 should be targeted for the insurance or annuity product and that members at levels 4-8 may not be as important to an enhanced member. In embodiments, other non-members may also be targeted for sales of the insurance and/or annuity products.

In embodiments, an online skill gaming system application server may communicate messages about the insurance product or annuity product to identified members or other consumers via their respective computing devices (whether mobile or desktop computing devices). In embodiments, messages may be communicated via online social media platforms (e.g., Instagram, Facebook, Twitter) alone and/or in conjunction with the online skill gaming application server 140 or 940 and/or other online skill gaming core servers 180 (980), 182 (982) and 184 (984). In embodiments, messages may include an enhanced member's URL as an identifier and/or a link for which to purchase the insurance or annuity product. In embodiments, invitation messages and/or communications may include price information about the insurance or annuity product.

In embodiments, an online skill gaming system application server 140 or 940 (or other core online skill gaming servers such as commissions server 184 (984), payment server 182 (982) and/or database server 180(980)) may receive 1010 communications indicating purchase of to the insurance and annuity product from an established member of the online skill gaming platform. In embodiments, in step 1015, an online skill gaming system application server 940 may also receive payment information which may be communicated and/or transferred to a third-party payment processing system for authentication that the member has made an acceptable payment. In embodiments, an online skill gaming system may further comprise a payment server 982 (e.g., or virtual payment server). In embodiments, online skill gaming system members and/or enhanced members may have payment accounts established (e.g., on a payment server 184 or 984) and thus may have virtual currency, which may be utilized to purchase the insurance or annuity product. In some embodiments, this may be referred to as a virtual wallet.

In embodiments, non-members of the online skill gaming platform may also purchase insurance or annuity products if they receive messages from established members of the online skill gaming platform to purchase the insurance or annuity products. In order to purchase the insurance or annuity product, the non-members must first join the online skill gaming platform. In embodiments, if these non-members join the online skill gaming platform, these new members become network affiliates (Level 1 networks) of the enhanced or established members, as is illustrated in step 1025. In embodiments, relationships between enhanced members and/or enhanced members network affiliates may be stored in an online skill gaming core server (e.g., an online skill gaming commission server 184 or 984). In embodiments, an account on the database server may be set up for the non-skill gaming members who joined the online skill gaming platform. In some embodiments, in step 1020, the new online skill gaming members may purchase the insurance or annuity products and make payment via a payment server (or via a third-party processing server).

In embodiments, in step 1030, after the new members or established members have purchased the insurance or annuity product, a commission server 184 (or 984) may allocate commission percentages to the corporate entity owning the online skill gaming platform, the enhanced members and/or other members in the variable level compensation program. In embodiments, in step 1035, computer-readable instructions executable by one or more processors of a commission server 984 (or other online skill gaming core servers) may communicate messages to the payment server 982 (or other online skill gaming core server) regarding payments and commissions to be distributed to the purchase of the insurance and/or annuity product. In some embodiments, in step 1040, computer-readable instructions executable by the one or more processors of the payment server (or other online skill gaming core server) may distribute a commission share to a corporate account in the payment server 182 or 982 or database server 180 or 980 for the insurance or annuity product. In some embodiments, in step 1045, computer-readable instructions executable by the one or more processors of the payment server (or other online skill gaming core server) may distribute a commission share for the insurance or annuity product to an enhanced member's accounts and/or other member's accounts (who are in the network of the enhanced member).

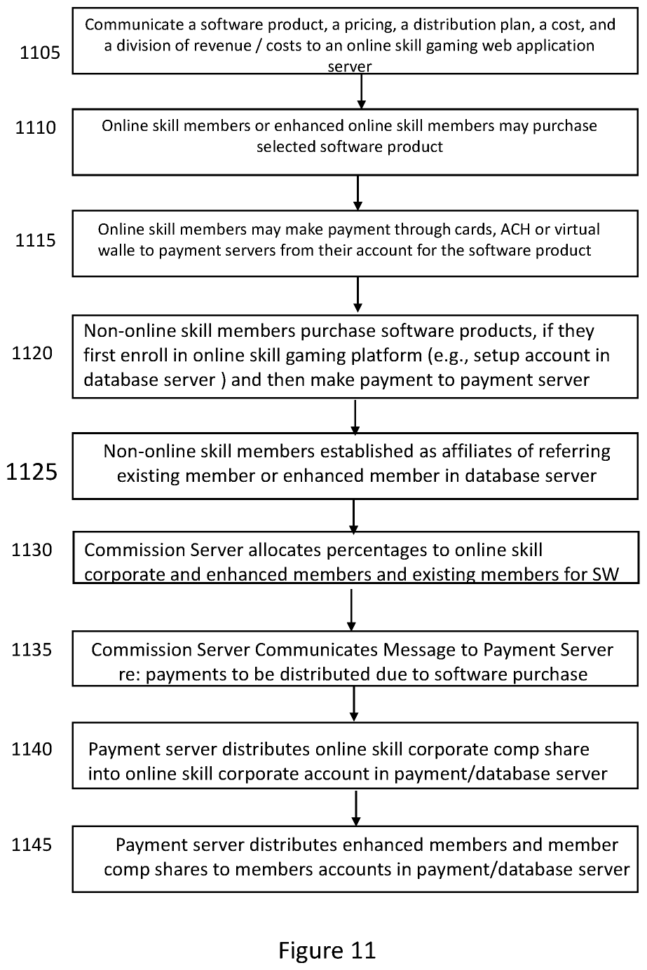

FIG. 11 is a description of compensation systems and methods applied to selling or distributing software according to some implementations. The methods and systems described above and below may be utilized in selling and/or distributing software products via a variable level marketing process according to some embodiments. In embodiments, computer-readable software on a mobile communication device and/or computing device may communicate 1105 a message to an online skill gaming system application server 140 or 940 identifying that a software product has been created, specifying a pricing of the software product, a distribution plan for promotion of the software product (e.g., which online skill gaming members and other consumers may be targeted), a cost of the software product, and a variable level commission plan (e.g., the divisions of commissions percentages) for the software product that may be sold on the online skill gaming system platform or on other computing systems.

In embodiments, this message may be communicated to one or more of a core group of servers (e.g., an application server 140 (940), a database server 180 (980), a payment processing server 182 (982) and/or a compensation server 184 (984). In embodiments, optionally, an online skill gaming application server 940 may communicate a report and/or parameters of a member's network level list to allow an enhanced member (or others that may be promoting or selling the software product) to identify levels of members who may be targeted or approached to purchase the software product. In embodiments, computer-readable instructions executable by a processor may perform analysis on the member network level list to identify targeted levels of members. For example, a member's network level list may identify that the member has 8 affiliates at level 1, 20 affiliates at level 2, 350 affiliates at level 3, and 10 affiliates each at levels 4-8. In embodiments, computer-readable instructions executable by a processor may identify that affiliates at levels 1-3 should be targeted for the software product and that at affiliates at levels 4-8 may not be as important to an enhanced member. In embodiments, other non-members may also be targeted for sales of the software products.

In embodiments, an online skill gaming system application server 940 may communicate messages about the software product to identified members or other consumers via their respective computing devices (whether mobile 910 or desktop computing devices 970). In embodiments, messages may be communicated via online social media platforms (e.g., Instagram, Facebook, Twitter) alone and/or in conjunction with the online skill gaming application server 140 or 940 and/or other online skill gaming core servers 180 (or 980), 182 (or 982) and 184 (or 984)). In embodiments, messages may include an enhanced member's URL as an identifier and/or a link for which to purchase the software product. In embodiments, invitation messages and/or communications may include price information about the software product.

In embodiments, an online skill gaming system application server (or other core online skill gaming servers such as commissions server 184 (or 984), payment server 182 (or 982) and/or database server 180 (or 980)) may receive 1110 communications indicating purchase of to the software product from an established member of the online skill gaming platform. In embodiments, in step 1115, an online skill gaming system application server may also receive payment information which may be communicated and/or transferred to a third-party payment processing system for authentication that the member has made an acceptable payment. In embodiments, an online skill gaming system may further comprise a payment server 982 (e.g., or virtual payment server). In embodiments, online skill gaming system members and/or enhanced members may have payment accounts established (e.g., on a payment server 184 or 982) and thus may have virtual currency, which may be utilized to purchase the software product.

In embodiments, non-members of the online skill gaming platform may also purchase software products if they receive messages from established members of the online skill gaming platform to purchase the software products. In order to purchase the software product, the non-members must first join the online skill gaming platform. In embodiments, if these non-members join the online skill gaming platform, these new members become network affiliates (Level 1 networks) of the enhanced or established members, as is illustrated in step 1125. In embodiments, relationships between enhanced members and/or enhanced members network affiliates may be stored in an online skill gaming core server (e.g., an online skill gaming commission server 184 or 984). In embodiments, an account on the database server may be set up for the non-skill gaming members who joined the online skill gaming platform. In some embodiments, in step 1120, the new online skill gaming members may purchase the software products and make payment via a payment server (or via a third-party processing server).

In embodiments, in step 1130, after the new members or established members have purchased the software product, a commission server 184 or 984 may allocate commission percentages to the corporate entity owning the online skill gaming platform, the enhanced members and/or other members in the variable level compensation program. In embodiments, in step 1135, computer-readable instructions executable by one or more processors of a commission server (or other online skill gaming core server) may communicate messages to the payment server 982 (or other online skill gaming core servers) regarding payments and commissions to be distributed to the purchase of the software product. In some embodiments, in step 1140, computer-readable instructions executable by the one or more processors of the payment server 982 (or other online skill gaming core server) may distribute a commission share to a corporate account in the payment server 182 or 982 or database server 180 or 980 for the sales of the software product. In some embodiments, in step 1145, computer-readable instructions executable by the one or more processors of the payment server 982 (or other online skill gaming core server) may distribute a commission share for the software product to an enhanced member's accounts and/or other member's accounts (who are in the network of the enhanced member).

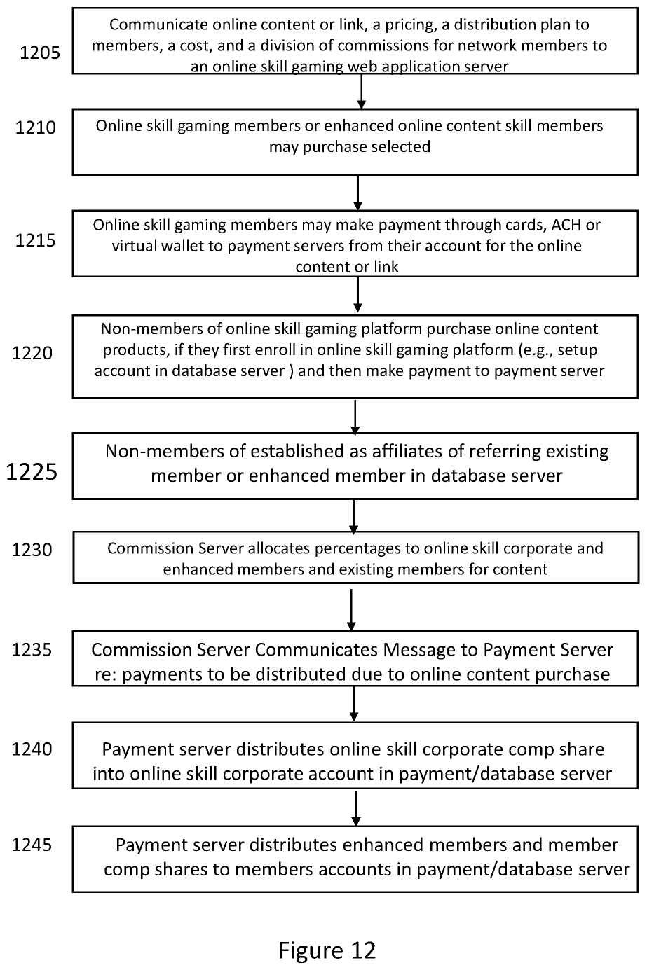

FIG. 12 is a description of compensation systems and methods applied to distributing content or paid content according to some implementations. The methods and systems described above and below may be utilized in selling and/or distributing online content or online content products via a variable level marketing process according to some embodiments. In some embodiments, this may be utilized in businesses like TikTok, Instagram and/or YouTube, where distributors may make money by creating content and/or distributing content. In embodiments, computer-readable software on a mobile communication device and/or computing device may communicate 1205 a message to an online skill gaming system application server 140 or 940 identifying that online content has been created, specifying a pricing of the online content or online content product, a distribution plan for promotion of the online content (e.g., which online skill gaming members and other consumers may be targeted), a cost of the creation of the online content, and a variable level commission plan (e.g., the divisions of commissions percentages) for the online content or online content product that may be sold on the online skill gaming system platform or on other computing systems.

In embodiments, this message may be communicated to one or more of a core group of servers (e.g., an application server 140 (or 940), a database server 180 (or 980), a payment processing server 182 (or 982) and/or a compensation server 184 (or 984)). In embodiments, optionally, an online skill gaming application server may communicate a report and/or parameters of a member's network level list to allow an enhanced member (or others that may be promoting or selling the online content) to identify levels of members who may be targeted or approached to purchase the online content. In embodiments, computer-readable instructions executable by a processor may perform analysis on the member network level list to identify targeted levels of members. For example, a member's network level list may identify that the member has 8 affiliates at level 1, 20 affiliates at level 2, 350 affiliates at level 3, and 10 affiliates each at levels 4-8. In embodiments, computer-readable instructions executable by a processor may identify that affiliates at levels 1-3 should be targeted for the online content and that affiliates at levels 4-8 may not be as important to an enhanced member. In embodiments, other non-members may also be targeted for sales of the online content.

In embodiments, an online skill gaming system application server 940 may communicate messages about the online content to identified members or other consumers via their respective computing devices (whether mobile 910 or desktop 970 computing devices). In embodiments, messages may be communicated via online social media platforms (e.g., Instagram, Facebook, Twitter) alone and/or in conjunction with the online skill gaming application server 140 (or 940) and/or other online skill gaming core servers 180 (980), 182 (982) and 184 (984)). In embodiments, messages may include an enhanced member's URL as an identifier and/or a link for which to purchase the online content. In embodiments, invitation messages and/or communications may include price information about the online content.

In embodiments, an online skill gaming system application server 940 (or other core online skill gaming servers such as commissions server 184 (984), payment server 182 (982) and/or database server 180 (980)) may receive 1210 communications indicating purchase of to the online content from an established member of the online skill gaming platform. In embodiments, in step 1215, an online skill gaming system application server 940 may also receive payment information which may be communicated and/or transferred to a third-party payment processing system for authentication that the member has made an acceptable payment for the online content. In embodiments, an online skill gaming system may further comprise a payment server 982 (e.g., or virtual payment server). In embodiments, online skill gaming system members and/or enhanced members may have payment accounts established (e.g., on a payment server 182 or 982) and thus may have virtual currency, which may be utilized to purchase the online content.

In embodiments, non-members of the online skill gaming platform may also purchase online content or online content products if they receive messages from established members of the online skill gaming platform to purchase the online content. In order to purchase the online content, the non-members must first join the online skill gaming platform. In embodiments, if these non-members join the online skill gaming platform, these new members become network affiliates (Level 1 networks) of the enhanced or established members, as is illustrated in step 1225. In embodiments, relationships between enhanced members and/or enhanced members network affiliates may be stored in an online skill gaming core server 905 (e.g., an online skill gaming commission server 184 or 984). In embodiments, an account on the database server 980 may be set up for the non-skill gaming members who joined the online skill gaming platform. In some embodiments, in step 1220, the new online skill gaming members may purchase the online content and make payment via a payment server 982 (or via a third-party processing server).

In embodiments, in step 1230, after the new members or established members have purchased the online content, a commission server 184 or 984 may allocate commission percentages to the corporate entity owning the online skill gaming platform, the enhanced members and/or other members in the variable level compensation program. In embodiments, in step 1235, computer-readable instructions executable by one or more processors of a commission server 984 (or other online skill gaming core server) may communicate messages to the payment server 982 (or other online skill gaming core server) regarding payments and commissions to be distributed to the purchase of the online content. In some embodiments, in step 1240, computer-readable instructions executable by the one or more processors of the payment server 982 (or other online skill gaming core server 905) may distribute a commission share to a corporate account in the payment server 182 (or 982) or database server 180 (or 980) for the sales of the online content or online content product. In some embodiments, in step 1245, computer-readable instructions executable by the one or more processors of the payment server 982 (or other online skill gaming core server) may distribute a commission share for the online content to an enhanced member's accounts and/or other member's accounts (who are in the network of the enhanced member).

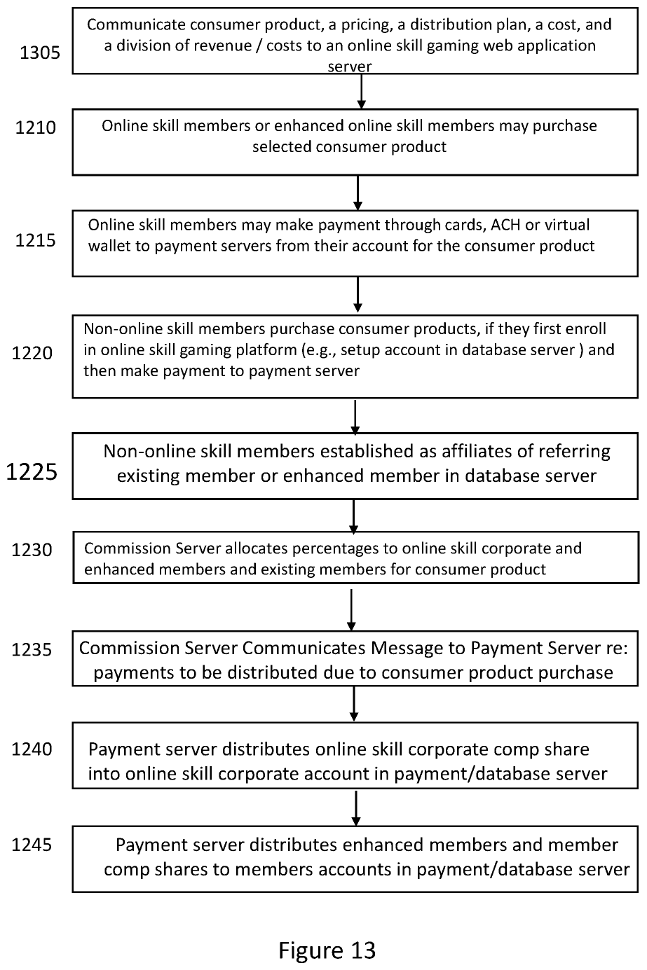

FIG. 13 is a description of compensation systems and method applied to selling sports-related or other consumer products according to some implementations. The methods and systems described above and below may be utilized in selling and/or distributing consumer products via a variable level marketing process according to some embodiments. In some embodiments, the consumer products may include athletic shoes, jerseys, memorabilia, sports equipment, NFTs, clothing, and/or other sponsored consumer products. In embodiments, computer-readable software on a mobile communication device 910 and/or computing device (e.g., desktop computing device 970) may communicate 1305 a message to an online skill gaming system application server 140 or 940 identifying the consumer product, specifying a pricing of the consumer product, a distribution plan for promotion of the consumer product (e.g., which online skill gaming members and other consumers may be targeted), a cost of the consumer product, and a variable level commission plan (e.g., the divisions of commissions percentages) for the consumer product that may be sold on the online skill gaming system platform or on other computing systems.

In embodiments, this message may be communicated to one or more of a core group of servers (e.g., an application server 140 (or 940), a database server 180 (or 980), a payment processing server 182 (or 982) and/or a compensation server 184 (or 984)). In embodiments, optionally, an online skill gaming application server 940 may communicate a report and/or parameters of a member's network level list to allow an enhanced member (or others that may be promoting or selling the online content) to identify levels of members who may be targeted or approached to purchase the consumer product. In embodiments, computer-readable instructions executable by a processor may perform analysis on the member network level list to identify targeted levels of members. For example, a member's network level list may identify that the member has 8 affiliates at level 1, 20 affiliates at level 2, 350 affiliates at level 3, and 10 affiliates each at levels 4-8. In embodiments, computer-readable instructions executable by a processor may identify that affiliates at levels 1-3 should be targeted for the consumer product and that affiliates at levels 4-8 may not be as important to an enhanced member. In embodiments, other non-members may also be targeted for sales of the consumer product.

In embodiments, an online skill gaming system application server 940 may communicate messages about the consumer product to identified members or other consumers via their respective computing devices (whether mobile 910 or desktop 970 computing devices). In embodiments, messages may be communicated via online social media platforms (e.g., Instagram, Facebook, Twitter) alone and/or in conjunction with the online skill gaming application server 140 (or 940) and/or other online skill gaming core servers 180 (or 980), 182 (or 982) and 184 (or 984)). In embodiments, messages may include an enhanced member's URL as an identifier and/or a link for which to purchase the consumer product. In embodiments, invitation messages and/or communications may include price information about the consumer product.

In embodiments, an online skill gaming system application server 940 (or other core online skill gaming servers such as commissions server 184 (or 984), payment server 182 (or 982) and/or database server 180 (or 980) may receive 1310 communications indicating purchase of to the consumer product from an established member of the online skill gaming platform. In embodiments, in step 1315, an online skill gaming system application server 940 may also receive payment information which may be communicated and/or transferred to a third-party payment processing system for authentication that the member has made an acceptable payment for the consumer product. In embodiments, an online skill gaming system may further comprise a payment server 982 (e.g., or virtual payment server). In embodiments, online skill gaming system members and/or enhanced members may have payment accounts established (e.g., on a payment server 184 or 982) and thus may have virtual currency, which may be utilized to purchase the consumer product.

In embodiments, non-members of the online skill gaming platform may also purchase promoted consumer products if they receive messages from established members of the online skill gaming platform to purchase the consumer product. In order to purchase the consumer product, the non-members must first join the online skill gaming platform. In embodiments, if these non-members join the online skill gaming platform, these new members become network affiliates (Level 1 networks) of the enhanced or established members, as is illustrated in step 1325. In embodiments, relationships between enhanced members and/or enhanced members network affiliates may be stored in an online skill gaming core server 905 (e.g., an online skill gaming commission server 184 or 984). In embodiments, an account on the database server 980 may be set up for the non-skill gaming members who joined the online skill gaming platform. In some embodiments, in step 1320, the new online skill gaming members may purchase the consumer product and make payment via a payment server 982 (or via a third-party processing server).

In embodiments, in step 1330, after the new members or established members have purchased the consumer product, a commission server 184 or 984 may allocate commission percentages to the corporate entity owning the online skill gaming platform, the enhanced members and/or other members in the variable level compensation program. In embodiments, in step 1335, computer-readable instructions executable by one or more processors of a commission server 984 (or other online skill gaming core server) may communicate messages to the payment server (or other online skill gaming core server) regarding payments and commissions to be distributed to the purchase of the consumer product. In some embodiments, in step 1240, computer-readable instructions executable by the one or more processors of the payment server 982 (or other online skill gaming core servers 905) may distribute a commission share to a corporate account in the payment server 182 (or 982) or database server 180 (or 980) for the sales of the consumer product. In some embodiments, in step 1245, computer-readable instructions executable by the one or more processors of the payment server (or other online skill gaming core server) may distribute a commission share for the consumer product to an enhanced member's accounts and/or other member's accounts (who are in the network of the enhanced member).

The software programs and applications described herein are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention. In embodiments, computer readable instructions may be executable by one or more processors of a computing device.

The computer readable storage medium (e.g., one or more memory devices and/or modules) can be a tangible device that can retain and store instructions for use by an instruction execution device (e.g., one or more processors and/or controllers). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (executable computer-readable instructions) described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions (executable computer-readable instructions) for carrying out operations of the online skill gaming system described herein may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions (executable computer-readable instructions) may execute entirely on a user's computing device and/or mobile communications device, partly on the user's computing device and/or mobile communications device, as a stand-alone software package, partly on the user's computing device and/or mobile communications device, and partly on a remote computing device (e.g., application and/or web server) or entirely on the remote computer or server (e.g., application server and/or web server). In the latter scenario, the remote computer or server (e.g., application server and/or web server) may be connected to the user's computing device and/or mobile communications device through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions (e.g., of the online skill gaming system) by utilizing state information of the computer readable program instructions to personalize the electronic circuitry, in order to perform aspects of the present invention.

Aspects described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (executable computer-readable instructions).

These computer readable program instructions (e.g., executable computer-readable instructions) may be provided to one or more processors and/or controllers of a general purpose computer, special purpose computer, or other programmable data processing apparatus to produce a machine and/or computing device, such that the computer-readable instructions, which execute via the one or more processors of the computing device or other programmable data processing apparatus, create methods, apparatus, and/or devices for implementing the functions/acts specified in the flowchart and/or block diagram block or blocks. These computer readable program instructions (executable computer-readable instructions) may also be stored in a computer readable storage medium (e.g., one or more memory devices and/or memory modules) that can direct a computing device, a mobile communications and/or computing device, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., executable computer-readable instructions) may also be loaded onto a computing device, server, mobile communications device and/or mobile computing device, other programmable data processing apparatus, or other devices to cause a series of operational steps to be performed on the computing device, server, mobile communications device and/or mobile computing device, other programmable apparatus or other device to produce a computer implemented (or computer processor-executable process), such that the instructions which execute on the computing device, server, mobile communications device and/or mobile computing device, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of computer-readable instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer-readable instructions. A person of ordinary skill in the art will recognize that any system, device, apparatus, process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A method, comprising:
one or more memory devices in a computing device;
one or more processors in the computing device,
computer-readable instructions stored in the one or more memory devices and executable by the one or more processors to cause the computing device to:
communicate a game establishment message to an online gaming system application server computing device identifying that an enhanced member would like to establish an online skill gaming tournament;
verify that an enhanced member meets predetermined criteria for being able to host the online skill gaming tournament on an online skill gaming computing platform;
communicate a message to the online skilling gaming application server computing device identifying a type of online skill game and online skill gaming tournament to be conducted;
communicate a message to the online skilling gaming application server identifying a number of players allowed in the online skill gaming tournament; an entry fee for the online skill gaming tournament; and a prize money distribution schedule for the online skill gaming tournament;
communicate or retrieve a report of the enhanced member's network level list to allow an enhanced member to identify levels of members who may be targeted to enter or participate in the online skill gaming tournament;
generate or select a commission distribution schedule for the online skill gaming tournament; and
communicate the commission distribution schedule for the online skill gaming tournament to the online skill gaming system application server.

2. The online skill gaming server computing device, comprising:
one or more memory devices in the online skill gaming server computing device;
one or more processors in the online skill gaming server computing device,
computer-readable instructions stored in the one or more memory devices and executable by the one or more processors to cause the online skill gaming server computing device to:
communicate online skill game tournament parameters in messages to network affiliates via the network affiliates' computing device to invite network affiliates to join an online skill gaming tournament established by an enhanced member;
receive communications from one or more member computing devices indicating entry into the enhanced member's established online skill gaming tournament;
receive instructions or messages from one or more member computing devices to play games and participate in the enhanced member's established online skill gaming tournament;
tabulate results for the one or more member computing devices for the games played in the enhanced member's established online skill gaming tournament;
distribute prize money to one or more member accounts or the one or more member computing devices that have highest tabulated results in the enhanced member's online skill gaming tournament, the distribution based on an established prize money schedule received from the enhanced member computing device; and
distribute enhanced member's commissions to enhanced member's accounts or enhanced member computing devices and network affiliates' commissions to network affiliates' accounts or network affiliates' computing devices based on a commission distribution schedule received from the enhanced member computing device or the commission server.
